(19) United States
(12) Patent Application Publication
(10) Pub. No.: US 2021/0238071 A1
(43) Pub. Date: Aug. 5, 2021

(54) PROCESS TO TREAT WASTE BRINE

(71) Applicant: SPOLEK PRO CHEMICKOU A HUTNI VYROBU, AKCIOVA SPOLECNOST, Usti nad Labem (CZ)

(72) Inventors: Petra KOVACOVA, Usti nad Labem (CZ); Bedrich DUBEN, Teplice (CZ); Pavel KUBICEK, Decin 6 (CZ)

(73) Assignee: SPOLEK PRO CHEMICKOU A HUTNI VYROBU, AKCIOVA SPOLECNOST, Usti nad Labem (CZ)

(21) Appl. No.: 17/262,926

(22) PCT Filed: Jul. 29, 2019
(86) PCT No.: PCT/CZ2019/000035

§ 371 Date: Jan. 25, 2021

(30) Foreign Application Priority Data
Jul. 27, 2018 (CZ) PV 2018-379

(51) Int. Cl. C02F 1/76; C02F 1/30; C02F 1/32; C02F 1/72; C02F 1/28

(52) U.S. Cl. CPC C02F 1/76; C02F 1/30; C02F 1/32; C02F 2103/36; C02F 1/281; C02F 1/283; C02F 1/722

(57) ABSTRACT

A process for removal of TOC from industrial aqueous waste streams which have TOC of 350000 mg/I or less and various pH, wherein the process comprises a plurality of successive steps comprising in each step electromagnetic irradiation in the region 200 nm-600 nm at a temperature of less than 70° C. for photo oxidation of the waste streams using an added oxidant.

The present invention relates to processes to treat waste brine from industrial chemical plants and achieve acceptable aqueous quality, with very low total organic content, for reutilisation.

Reduction of an organic contamination in the brine can be achieved by evaporation/concentration step followed by crystallization of respective salt, which may be then further treated by subsequent salt calcination step, which also involves a high temperature oxidation. These methods, however, involve high investment costs and high energy demand.

Oxidation of waste waters is well studied for reducing the TOC of the waste waters and when using hypochlorites or peroxides, low pH, as low as 1, is used. This presents difficulties in achieving stable corrosion-free treatment plants and it is desirable to seek treatments with relatively better pH conditions. Surprisingly processes described herein, using UV-VISIBLE photolysis, work effectively in the pH range 3-7.5, under low temperatures, low pressures, and, in this relatively mild process region, any unwanted chlorate formation is avoided/minimised and the desired very low TOC is achieved. The pH below 7 is also important and essential to limit of formation of deposits on light emitter surface (scaling of the surface).

Prior art attempts to reduce TOC are disclosed, such as in following art:

WO2009/095429 relates to a process for degrading organic substances present in aqueous compositions, by oxidation, and describes the need to ensure that chlorate formation is avoided, particularly in the type of oxidation described therein. This art states that “a good compromise can be obtained between the oxidation rate of the organic substances which is targeted, the chlorination of the organic substances to give chlorinated organic substances highly resistant to oxidation which has to be avoided, and the chlorate formation which has to be avoided.” Several embodiments of oxidation are suggested, amongst them is the use of UV irradiation in a third variant of a third embodiment, in a step (b2), which is termed the “chloro-photolysis treatment”, and that this provides reduction of TOC levels to lower than or equal to 10 mg C/I. Example 14 in WO2009/095429 uses a brine which has TOC of 0.085 g C/I and, with UV irradiation and aqueous solution of sodium hypochlorite, is converted to brine having TOC content was 0.015 g C/I. The examples in WO2009/095429 have relatively low TOC starting amounts, and after treatments still have organic residuals, typically about 0.025 g C/I.

This WO2009/095429 art states that “The chloro-photolysis treatment could also be carried out in place of step (a) or of step (b2). This would however be useful when the content of the organic substances in the aqueous solution to be treated is low.” Thus ability to degrade considerably the starting high TOC of the type described herein is not obvious from this art.

WO2012167297 concerns high-pressure wet oxidation with iron (II) salts as catalysts and oxygen as an oxidant at temperatures of 170 to 260° C. It is mentioned that “Conventional processes for wet oxidation, such as peroxide, hypochlorite, UV, ozone, and electro-oxidation excrete because of inefficiency from”.

Generally in the field of industrial waste water, there has been progressive development of advanced oxidation processes (AOP). These processes are based on the principle of non-selective oxidation mediated by OH radicals. OH radicals react with any compound capable of oxidation, which reaction leads to a subsequent sequence of oxidative degradation reactions. AOP are performed at normal temperature and pressure. The oldest known AOP is Fenton oxidation, which is a reaction of hydrogen peroxide with bivalent iron in an acidic environment. The Fenton oxidation reaction has been modified in various ways, but these cannot be labeled as standard Fenton reaction. In such processes, an iron in the other oxidation state as a catalyst or other metals or other source of radical or different photo- and electro-Fenton reactions are used. Photo-Fenton reaction is strongly accelerated by using UV radiation. In such AOP processes, use of H₂O₂/Fe²⁺/UV or H₂O₂/Fe³⁺/UV systems or solution of hydrogen peroxide with tris(oxalate)ferrite salt H₂O₂/[Fe^{III}(C₂O₄)₃]³⁻/UV are described. Above modifications also allow the use of radiation with wavelength up to 550 nm: thus photons of lower energy can be used with the participation of Fe²⁺ or Fe³⁺ ions. Our study with this type of photo-oxidation shows that despite the efficacy, there is still further improvement needed in photo oxidation systems to reach the less than 10 mg/I target in TOC.

The present invention relates to a method for reduction of Total Organic Carbon (TOC) in waste water streams coming from various industrial processes, for example that aqueous waste originating from i) the production of Liquid Epoxy Resin (LER) using the alkaline reaction of various bisphenols, hydrogenated bisphenols and epichlorohydrin or dichloropropanol, ii) the production of epichlorohydrin (ECH) from dichloropropanol using alkaline reagents, iii) the production of unsaturated polyesters from acids, anhydrides and alcohols, iv) the brine from a chloro-alkali plant, and/or v) the brine generally from dehydrochlorination processes, more specifically dehydrochlorination of chlorohydrines or chlorinated C₃-C₆ hydrocarbons, etc.,

The aqueous waste streams from such processes generally is alkaline, with high salt content, e.g. 300 g/I, and has significant TOC, e.g. 4000 mg/I, 3000 mg/, 2500 mg/I, or 2000 mg/I. Such waste is also referred to “highly alkaline brines”, and may comprise a range of organic impurities, e.g. hydrocarbons (e.g. C₃-C₅ alcohols, aldehydes, carboxylic acids, and oligomeric species derived from these types of compounds), as well as inorganic salts (such as sodium, potassium or calcium as chlorides, hydroxides, chlorates, etc.). Glycerin maybe a main component of the TOC of such streams and is difficult to remove to very low amounts: glycerin maybe present in the range from 0.37 to 3.5 g/I in the waste feed requiring to be treated.

There is therefore a continuing need to improve on processes to treat such aqueous waste stream with high TOC and salt content, and achieve acceptable aqueous quality for subsequent safe disposal or reutilisation, where the TOC is 10 mg/I or less. Particularly it is important that chlorates are not formed during the treatment. A particular reutilisation of such treated waste water, where the resultant TOC is 10 mg/I or less and particularly also chlorates are not formed during the treatment, is as brine in a chlor-alkali membrane plant to produce chlorine.

The waste treatment processes described herein are useful for reducing the TOC especially from highly contaminated brines, which may have also glycerin as a contaminant, whilst also ensuring there is full control/minimisation of any chlorate formation arising from the treatment.

The industrial waste water streams maybe are from a facility with several integrated processes comprising for example the mentioned ECH, LER, and/or polyester production processes, and utilising a chlor-alkali membrane system. Thus the aqueous waste streams to be treated may have various combinations of the organics, in the content as well as in the type of organic impurity, comprising the TOC, as well as in the inorganic salt content and type.

The content of the TOC in such waste streams can range from process to process and over time variously, e.g. from 300,000 mg TOC/I to about 100 mg TOC/I, depending on the production conditions operating in the various chemical units, especially in an integrated plant and therefore the efficiency of TOC removal can vary from about 50% per one treatment step to about 99.9% in another.

It is therefore important to have a treatment method that is flexible to handle various quality of the waste water feed, and yet deliver consistently lower, acceptable TOC after treatment.

Furthermore, the pH of the waste streams can be of various pH values. Thus a flexible treatment process is important to handle such waste streams with various pH.

The inorganic components of the aqueous waste stream may have chlorate impurities, either already present or produced in situ during treatments of the aqueous waste stream. Chlorates are being closely monitored and regulated due to their known toxicity, e.g. adverse effect on red blood cells and inhibition of iodine uptake in the thyroid gland. There is a need in the chemical industry that chlorate content from aqueous waste streams is set at low levels to prevent contamination of water sources, e.g. up to 1 mg/I of chlorates or up to 10 mg/I. There are also known limits on chlorates in the chemical industry processes, e.g. in chlor-alkali electrolysis of brine, where chlorates in brine must be expensively destroyed.

Therefore the processes developed for reducing the TOC of the types of aqueous waste streams as described herein should not create large amounts of chlorates.

The present invention relates to a method for reduction of Total Organic Carbon (TOC) in aqueous waste water streams, originating from i) the production of Liquid Epoxy Resin (LER) using the alkaline reaction of various bisphenols, hydrogenated bisphenols and epichlorohydrin or dichloropropanol, ii) the production of epichlorohydrin (ECH) from dichloropropanol using alkaline reagents, iii) the production of unsaturated polyesters from acids, anhydrides and alcohols, iv) the brine from a chlor-alkali plant and/or v) the brine generally from dehydrochlorination processes, more specifically dehydrochlorination of chlorohydrines or chlorinated C3-C6 hydrocarbons, etc., to achieve a final TOC amount of less than 10 mg/I.

Surprisingly, effective selective reduction of the organics is achieved under relatively mild conditions as described in the present invention, for high TOC containing brines, using low temperature Electromagnetic irradiation (200 nm-600 nm) promoted oxidation, without formation of problematical chlorates side products.

Importantly, this invention enables effective reuse of such treated brines in chlor-alkali plants or reuse of treated water back into other chemical processes such as e.g. solvent, washing water, make-up water etc.

Surprisingly it has been found in the method of present invention that brines, with high starting TOC and various pH, can be successfully treated by the photo oxidation and/or a combination of photo oxidation and adsorption processes to achieve reduction of organic content to less than 10 mg/I and without increase in chlorates.

Thus, according to a first aspect of the present invention, there is provided a process for treating industrial aqueous waste streams which have TOG of 300,000 mg/I or less, more particularly 10,000 mg/I or less, inorganic salts content of 320 g/I or less and various pH, wherein the process comprises a step a) and optionally step b), wherein

step a) comprises low temperature electromagnetic irradiation, in the region 200 nm-600 nm, for photo oxidation of the waste streams, using an oxidant, and

step b) comprises treatment of the output of step a) with physical absorbers to achieve TOC 100 mg/I or less, 50 mg/I or less, 25 mg/I or less, 15 mg/I or less, 10 mg/I or less, 5 mg/I or less.

In embodiments step a) may consist of series or plurality of chemical steps, which may be promoted, catalysed or not, and the Electromagnetic irradiation (200 nm-600 nm) can be delivered from various wave lengths generated by Hg low-, medium- and high-pressure lamps or LED emitters. Examples of electromagnetic irradiation (200 nm-600 nm) include using UV-C radiation, e.g. wavelength 254 nm.

The step a) chemical steps use oxidizing agents, actively added to the waste stream, or generated in-situ. The purpose of these oxidising agents is to cause degradation finally to gaseous molecules such as carbon dioxide, water, etc. Use of Electromagnetic irradiation (200 nm-600 nm) exposure combined with oxidising agents has been found to cause successful degradation of a much greater portion of the organic content in aqueous waste streams, under relatively mild conditions of low temperature, pressure, and in a useful pH range, and low usage of oxidants.

The amount of the oxidising agent in step a) which should be provided is surprisingly found to be needed in low amounts. This enables further cost savings as well as reduction in any further need to treat for the end products of such oxidising agents. In embodiments of the invention, the stoichiometric ratio of oxidising agent:industrial waste water TOC feed may range from about 0.5:1.0 to 5.0:1.0. In specific embodiments, the oxidising agent provided to the step a) treatment zone may be controlled to ensure that a slight stoichiometric excess of oxidising agent is present.

In embodiments, examples of oxidising agents are peroxides, hypochlorites, such as hydrogen peroxide, chlorine, hypochlorite, chlorine dioxide, dichlorine monoxide, oxygen, ozone and any mixture thereof.

In embodiments, the step a) photo oxidation is conducted at a pH in the range 4.5-7.5, which can be preferably adjusted in the industrial aqueous waste water streams feed by e.g. addition of an acid, e.g. hydrochloric acid, typically of 37% strength.

In embodiments, the step a) photo oxidation is conducted under surprisingly low temperature, for example at temperatures of less than 90° C., e.g. less than 80° C., less than 75° C., less than 70° C., less than 65° C. or less than 60° C. This is an important feature as it significantly enables energy cost efficiency and flexibility in reactor vessel design and longevity in continuous industrial use. In embodiments, such low temperature and the combination of appropriate process conditions as described herein, dramatically reduce the formation of (unwanted) chlorates in the treatment reactor.

In embodiments, the step a) photo oxidation is conducted under surprisingly low pressure conditions, such as atmospheric or low range superatmospheric pressure, i.e. at a pressure in the range from about 100 kPa to about 150 kPa. This feature also significantly enables energy cost efficiency and reactor vessel design and longevity.

In a preferred embodiment the photo oxidising agent is chlorine and is used in 0.8 to 1.0 times the theoretical consumption of chlorine required to consume the TOC. The pH value is the range of 5.5-7.0, preferably 5.5-6.8.

There may be sequential (in series or parallel) photo oxidations using the chlorine as the photo oxidant, and using vessels having drum stirrers, or flow column reactors. Surprisingly it has been found that such treatments enable good reduction of TOC without excessive increase in chlorates or use of very low pH.

In this simplified scheme of sequential photo oxidations using chlorine, photo oxidation steps a1), a2) etc., have been shown to provide surprisingly effective reduction of TOC brine from an epichlorohydrin production plant or an epoxy resin production plant, from e.g. 5400 mg/L to 611 mg/I in step a1), and then to 77 mg/I after step a2), with good energy utlilisation.

After these photo oxidation steps a1), a2) etc., using chlorine as the photo oxidant, the TOC can be further optionally treated with an additional oxidising agent, such as hydrogen peroxide, hypochlorite etc.

In a final step, step b), the reaction mixture is then deeply acidified and treated with microporous ion exchange resins. Thus, acidification is left for the final step, largely avoiding corrosion issues in the earlier steps a1, a2, etc. This represents a significant saving in energetics and achieving long life to the reaction vessels.

In an embodiment the oxidising agent is a hypochlorite, e.g. sodium hypochlorite NaClO, and is used in low stoichiometric excess, e.g. from 0% to 100%. Thus the stoichiometric excess of the NaClO maybe set with the ratio NaClO:TOC in the range 1.0:1.0 to 2.0:1.0, or from 0% to 50% of stoichiometric excess, i.e. stoichiometric excess of NaClO:TOC in range from 1.0:1.0 to 1.5:1.0.

To avoid any misunderstanding, the stoichiometric amount of NaClO to TOC is 2 moles NaClO to 1 mol TOC (carbon). Thus the stoichiometric excess of NaClO 50% means 3 moles NaClO to 1 mol TOC, and the stoichiometric excess 1.5:1.0 means also 3 (=1.5*2) moles NaClO to 1 mol TOC.

In an embodiment, the step a) photo oxidation uses a peroxide, for example hydrogen peroxide H₂O₂, which is used in low stoichiometric excess, or even in deficit, e.g. in stoichiometric ratio H₂O₂ to TOC in range from 0.5:1.0 to 2.0:1.0 more particularly 0.7:1.0 to 1.2:1.0. To avoid any misunderstanding the stoichiometric amount of H₂O₂ to TOC is 2 moles H₂O₂ to 1 mol TOC (carbon).

The pH of the reaction mixture maybe in the region 4.0-7.5, which is useful in limiting corrosion in vessels used and limiting of the formation of (scaling, polymeric, or tarry) deposits on light emitter surface. The brines are from various sources, and have various pH, and the control of pH is essential in the reactor: therefore the pH of the brine waste water can be tuned just before feed into the reactor. In present case the pH of the brine is pre-tuned to ensure a final pH of treated brine 5-6.

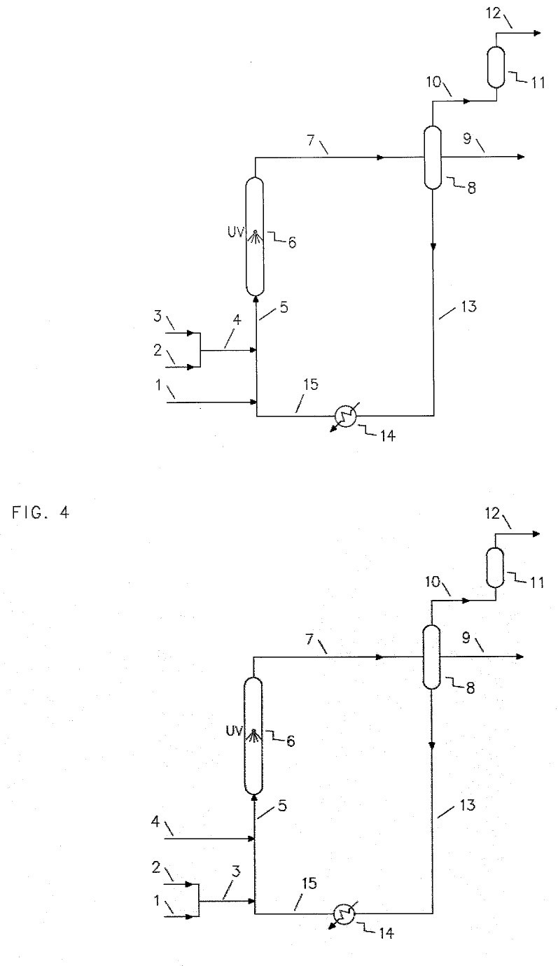

The method of removal of TOC according to present invention does not contribute to significant formation of chlorates. The chlorates can only come in large extent with the treatment feedstreams, e.g. from hypochlorite. In embodiments, the formation of chlorates can be avoided by the preparation of the oxidising agent, e.g. the hypochlorite agent, just before introduction to the process or by generating of hypochlorite in-situ. As an example sodium hypochlorite can be freshly prepared by introducing of chlorine gas into the sodium hydroxide solution under appropriately low temperature (see FIG. 3) or by introduction of chlorine gas directly to the alkaline environment before the reactor, e.g. in the external reactor circulation (see FIG. 4).

We surprisingly found that under low temperatures, appropriate low pH and having the appropriate oxidizing agent in excess, the chlorate formation rate during the process is limited to such an extent, that, in embodiments, the amount of chlorates formed in milligram (mg), with respect to 1 gram (g) of TOC removed, is in range of 1500 mg ClO³⁻/g or less, 1000 mg/g or less, 500 mg/g or less, 100 mg/g or less, 10 mg/g or less, or 1 mg ClO³⁻/g of TOC removed.

In embodiments, the oxidising agent may be fed into the step a) treatment as a liquid (see FIG. 1), or as a gas (see FIG. 3, FIG. 4) and becomes dissolved in the liquid reaction environment with industrial water waste in the step a) zone.

In embodiments, the oxidising agent is fed into step a) treatment via dispersing devices, for example, nozzles, porous plates, tubes, ejectors, etc. The oxidant agent in embodiments of the invention, may be fed directly into the industrial water waste or additionally or alternatively, there may be different agents being mixed before step a) and then fed into step a).

Additional vigorous stirring may be used to ensure good mixing and/or dissolution of the oxidising agent into the industrial waste water.

As those skilled in the art will recognise, the photo oxidation steps, e.g. step a1), step a2) etc, can be maintained at target temperatures through use of cooling/heating elements such as cooling tubes, cooling jackets, cooling spirals, heat exchangers, heating fans, heating jackets or the like. In embodiments the photo oxidising is conducted with the Electromagnetic irradiation 200 nm-600 nm is supplied to the step a) treatment zone using glass tube, the tube may additionally be configured to enable the flow therethrough of a coolant (e.g. water). The operating temperature in the step a) treatment zone may be controlled by any temperature control means known to those skilled in the art, for example heating and/or cooling means such as heating/cooling jackets, heating/cooling loops either internal or external to the reactor, cooling spirals, heat exchangers, heating fan and the like. Additionally or alternatively, the temperature may be controlled by controlling the temperature of material/s added into the step a) treatment zone, thus, controlling the temperature of the reaction mixture therein. The industrial waste water is maintained in the step a) treatment zone for a time and under conditions sufficient to achieve the required level of degradation of the organic content.

In embodiments, this method according to present invention efficiently removes TOC from aqueous solution and forms CO₂ as a product of oxidation of such TOC. Surprisingly, in embodiments, the content of CO in CO₂ is found to be low e.g. only up to 50,000 ppm vol, up to 10,000 ppm vol, or up to 1000 ppm vol. or up to 100 ppm vol or up to 10 ppm vol. of CO in CO₂. In embodiments, the amount of CO produced can be also partially controlled by excess of oxidizing agent in reactor. Nevertheless any method known for either after-oxidation of CO to CO₂ or removal of TOC can be further implemented, if required. Typical method for oxidation of CO to CO₂ is low temp catalytic oxidation by oxygen/air, high temp oxidation by oxygen/air, i.e. combustion etc.

In embodiments, the purity of CO₂ in terms of TOC is surprisingly high, e.g. with only up to 100 mg/I, up to 10 mg/I or up to 1 mg/I of TOC in CO₂. For efficient removal of any residual TOC in CO₂, any method such as adsorption on e.g. active carbon can be used. TOC can be also destroyed by combustion/incineration, e.g. together with CO oxidation.

Reactors used in the processes of the present invention may be divided into different zones each having different flow patterns and/or different operating temperatures/pressures. For example, step a) may be performed in a reactor including a plurality of treatment zones. Those zones may be operated at different temperatures and/or pressures and/or oxidising agent type or amount. The plurality of treatment zones may therefore involve a plurality of step a) processes, and these plurality of step a) are termed step a1), step a2), step a3), etc.

Additionally or alternatively, reactors used in the processes of the present invention may be advantageously provided with external circulation loops. The external circulation loops may optionally be provided with cooling and/or heating means. This circulation loop allows better turbulent regime in the reactor.

As those skilled in the art will recognise, step a) treatment zones can be maintained at differing temperatures through use of cooling/heating elements such as cooling tubes, cooling jackets, cooling spirals, heat exchangers, heating fans, heating jackets or the like.

The skilled reader will also appreciate that such apparatus, especially in systems which are operated on a continuous basis, will comprise conduits (e.g. pipes) to carry the industrial waste water feed, oxidising agent feed, partially treated intermediate waste water and other materials. In embodiments of the invention, the connections between these conduits and other components of the system may be configured to avoid corrosion.

In step b), which is performed generally after step a), physical adsorbers are used to remove remaining organic residues. These physical adsorbers are preferably those that adsorb organic residues. Some organic residues in the industrial aqueous waste streams are sometime difficult to completely oxidise to gaseous by products in step a). These residues maybe from the original industrial aqueous waste streams feed and maybe also from partially degraded carbon compounds from step a).

In embodiments of step b) microporous absorbers are found suitable to reduce or remove such residues. Examples of microporous adsorbers are microporous activated carbon with uniform cells size, microporous zeolites, carbonaceous compounds, such as graphene, carbon nanotubes etc.

In embodiments of step b), the pH is maintained lower than 3.5, by e.g. acidification of the output of step a), using e.g. concentrated hydrochloric acid. Surprisingly, the microporous adsorbers as mentioned above, when in such pH conditions, remove efficiently the organic residual content after the step a).

The adsorbers may be present in granular form or suspended/attached to suitable support, such as a membrane, and the adsorbers maybe in column. Washing and regeneration of the adsorbers, e.g. present in e.g. adsorption column, is carried out using hot demineralised water or steam, optionally using a weak alkaline solution. Waste water from the washing and regeneration of the absorbers can be further treated by recycling back to the step a) of present invention or in the biological wastewater treatment plant or other appropriate treatment.

In embodiments of step b), the TOC organic residues are combinations of higher order, e.g. C3-C5 oxygenated compounds, such as polyols, chlorinated and/or hydroxylated, carboxylic acids or esters, oligomers, and maybe present in amounts 500 mg/I, 250 mg/I, 100 mg/I, 50 mg/I, or 25 mg/I or 20 mg/I, or 15 mg/I.

After step b), the TOC organic residues are 10 mg/I or less, 5 mg/I or less.

In embodiments, the TOC content of the treated industrial waste water streams, extracted from the step a) and step b) two-step process is about 1000 mg/I or less, about 500 mg/I or less, about 200 mg/I or less, about 150 mg/I or less, about 100 mg/I or less, about 50 mg/I or less, about 20 mg/I or less or about 10 mg/I or less, or about 5 mg/I or less.

In embodiments, step b) maybe performed in-between the plurality of steps in step a), for even more controlled removal/treatment of the organics as the treatment progresses through the series of steps.

In embodiments, the aqueous waste water comes from a plant producing liquid epoxy resins LER which are compounds having two independent epoxy rings and are produced in an etherification/dehydrochlorination process from epichlorohydrin and various bisphenol or other hydroxy- or carboxy-containing compounds, in the presence of an alkaline agent which acts either as catalyst for the etherification or esterification reaction or reactant for dehydrochlorination to form epoxy groups. The LER production is thus typically subdivided into following phases involving etherification, first and second dehydrochlorination, neutralization and washing, concentration and filtration. In the first dehydrochlorination step, an alkali reagent and an, optionally, an auxiliary solvent are added, excess of epichlorohydrin is distilled off and dehydrochlorination is then almost completed. Waste water formed in the first dehydrochlorination step is used as an illustrative example of brine to be treated using process according to the present invention. Step b) according to present invention has particularly advantageous adsorption of the higher order TOC organic compounds onto the microporous adsorbers and the resultant treated waste brine with very low TOC overall can be recycled successfully back to chlor-alkali membrane electrolysis plant.

In embodiments of present invention, the Total Organic Carbon (TOC) is reduced in waste brines originating from the dehydrochlorination step of the production of epichlorohydrin, which industrial production is based on the dehydrochlorination reaction of dichloropropanols, by means of a suitable alkaline agent such as caustic soda (NaOH), milk of lime (Ca(OH)₂), or partially calcium carbonate CaCO₃ etc. Epichlorohydrin formed is then stripped out from the reaction mixture and the waste stream leaving such reaction system consists mainly of water, respective salts, organics (as TOC or COD, AOX) and some catalyst residue if used in epichlorohydrin production. Dichloropropanols can be produced from glycerine and HCl, from allyl chloride and HOCl acid or from allyl alcohol and chlorine gas. The waste water formed in the dehydrochlorination step using milk of lime is used as an illustrative example of brine to be treated using process step a) according to the present invention. In this case (of using milk of lime), step b) consists then of a standard bio treatment in an active sludge process. If caustic soda is used instead of milk of lime, then step b) according to present invention is advantageously the adsorption on microporous adsorbers and the treated waste brine can be recycled back to a chlor-alkali membrane electrolysis plant.

In embodiments of present invention, the Total Organic Carbon (TOC) is reduced in waste water originating from the production of polyester resins, e.g. industrial production of unsaturated polyesters derived from the polycondensation (polyesterification) of unsaturated and saturated dicarboxylic acids with diols. Esterification is generally performed with a slight excess (up to 10%) of diols. The water formed in the reaction is distilled off and this water is contaminated by such alcohols. Such wastewater is used as an illustrative example of wastewater stream to be treated using process according to the present invention.

In embodiments of the invention, organic contamination in the form of glycerin is reduced/removed. Glycerin contamination occurs from e.g. an epichlorohydrin ECH plant and can be effectively removed by biological purification (see e.g. WO2009/026208) conducted in the wastewater treatment plant. The major problem with this type of treatment is the high concentration of NaCl that accompanies the organic contamination. High salinity of waste waters causes plasmolysis and/or the loss of cell activity, which results in a significant decrease in the effectiveness of the biological purification. High salinity also influences the rate of bacteria dispersion growth, which in a certain extent negatively affects the quality of the final effluent. Therefore, a high degree of dilution using pure water is necessary to achieve a concentration of NaCl in the range of some 10-30 g/I, more typically 10-20 g/I and this results in an uneconomic increase of the total amount of waste water, and without any chloride ion content reduction in such water, these chloride ions are discharged into the recipient.

In embodiments, examples of organic materials that may be present in the industrial water waste employed in the processes of the present invention include such as linear and cyclic polyols, esterified polyols, oxygenated poll compounds, chlorinated polyol compounds and other compounds. The examples are glycerin and polyglycerines, glycidol, monochloroproanediol, dichloroproanol, ethyleneglycol, propyleneglycol, 2,3-dichloropropanoyl acid,

Thus the invention has following non exhaustive aspects:

1. A process for removal of TOC from industrial aqueous waste streams which have TOC of 350000 mg/I or less and various pH, wherein the process comprises a plurality of successive photo oxidation steps comprising in each step electromagnetic irradiation in the region 200 nm-600 nm at a temperature below 70° C. for photo oxidation of the waste streams using an added oxidant.

The above process, wherein the oxidant is used in a stoichiometric excess to TOC of from 0.5:1.0 to 5.0:1.0.

The above process, wherein the oxidant is selected from hypochlorites and peroxides.

The above process, wherein the photo oxidation of the waste streams using an added oxidant is carried out under pH lower than 7.0.

The above process where the photo oxidation is conducted under surprisingly low pressure conditions, such as atmospheric or low range superatmospheric pressure, i.e. at a pressure in the range from about 100 kPa to about 150 kPa.

2. The above process, wherein, following the plurality of photo oxidation steps, the waste streams are treated with at least one physical adsorber to achieve final TOC 10000 mg/I or less, 1000 mg/I or less, 100 mg/I or less, 50 mg/I or less, 25 mg/I or less, 15 mg/I or less, 10 mg/I or less, 5 mg/I or less.

The above process, wherein the physical adsorber is selected from the group consisting of microporous absorbers, such as microporous activated carbon with uniform cells size, microporous zeolites, or carbonaceous compounds, such as graphene, or carbon nanotubes.

The above process, wherein, prior to treatment with physical absorbers, the pH of the treated streams is reduced to below 6.

The above process, wherein the resulting stream is recycled to the process of claim 1.

The above process, wherein industrial waste water streams are used that come from i) the production of Liquid Epoxy Resin (LER) using the alkaline reaction of various bisphenols, hydrogenated bisphenols, and epichlorohydrin or dichloropropanol, ii) the production of epichlorohydrin (ECH) from dichloropropanol using alkaline reagents, iii) the production of unsaturated polyesters from acids, anhydrides and alcohols, iv) the brine from a chlor-alkali plant and/or v) the waste water generally from dehydrochlorination processes, more specifically dehydrochlorination of chlorohydrines or chlorinated C₃-C₆ hydrocarbons.

The above process, wherein the TOC organic materials in the industrial water waste include linear and cyclic polyols, esterified polyols, oxygenated poll compounds, chlorinated polyol compounds and/or other compounds, e.g. glycerin, polyglycerines, glycidol, monochloroproanediol, dichloroproanol, ethyleneglycol, propyleneglycol, 2,3-dichloropropanoyl acid,

The process of any one of the preceding claims, wherein the TOC organic residues comprises combinations of higher order, e.g. C₃-C₅ oxygenated compounds, such as polyols, chlorinated and/or hydroxylated, carboxylic acids or esters, oligomers, and maybe present in amounts 500 mg/I, 250 mg/I, 100 mg/I, 50 mg/I, or 25 mg/I or 20 mg/I, or 15 mg/I.

The invention is elucidated with reference to the accompanying figures, wherein the various reference numerals have the following meaning:

FIG. 1: UV-Photoreaction Using Oxidising Agent (Generally)
1—Crude wastewater (brine)
2—Oxidizing agent (hypochlorite, hydrogen peroxide)
3—Reactor inlet
4—Photoreactor
5—Reactor outlet
6—Reaction mixture separator
7—Treated (purified) waste water (brine)
8—CO₂ crude gas
9—CO₂ treatment
10—CO₂ off gas
11—Reactor circulation
12—Cooler
13—Reactor cooled circulation

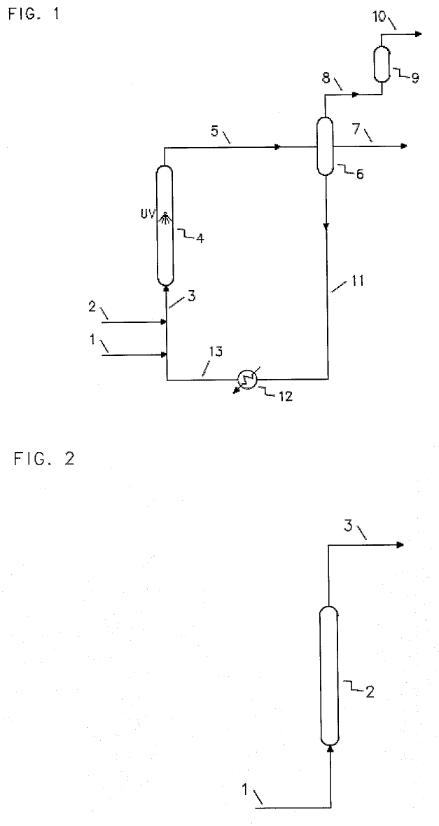

FIG. 2: Wastewater (Brine) Aftertreatment
1—Wastewater (brine) inlet
2—Adsorption column
3—Purified wastewater (brine) outlet

FIG. 3: UV-Photoreaction with Fresh Hypochlorite
1—Crude wastewater (brine)
2—Chlorine gas
3—Caustic soda solution
4—Fresh hypochlorite
5—Reactor inlet
6—Photoreactor
7—Reactor outlet
8—Reaction mixture separator
9—Treated (purified) waste water (brine)
10—CO₂ crude gas
11—CO₂ treatment
12—CO₂ off gas
13—Reactor circulation
14—Cooler
15—Reactor cooled circulation

FIG. 4: UV-Photoreaction with Hypochlorite Generated In Situ
1—Crude wastewater (brine)
2—Caustic soda solution
3—Alkaline wastewater (brine)
4—Chlorine gas
5—Reactor inlet
6—Photoreactor
7—Reactor outlet
8—Reaction mixture separator
9—Treated (purified) waste water (brine)
10—CO₂ crude gas
11—CO₂ treatment
12—CO₂ off gas
13—Reactor circulation
14—Cooler
15—Reactor cooled circulation

The invention is now further illustrated in the following examples, both COMPARATIVE and INVENTION. In those examples, the following abbreviations are used:

### Abbreviations Used/Definitions of Terms

LER=liquid epoxy resin
ECH=epichlorohydrin
PET=polyester resin
GLY=glycerin
TOC=Total Organic Carbon
COD=Chemical Oxygen Demand
ThOD=Theoretical Oxygen Demand
Initial TOC=TOC at the inlet of the reactor before the treatment was performed
Final TOC=TOC at the outlet of the reactor after the treatment was performed
BV/h=bed volume per hour (volume per hours of liquid to be treated)

### COMPARATIVE PROCESSES

### Comparative 1. Non Electromagnetic Accelerated Process

TOC oxidation with sodium hypochlorite using Accent™ 91-5 nickel catalyst (produced by Johnson Matthey Catalyst)

A general process to reduce the organic content of brines originating in the production process for LER is oxidation with sodium hypochlorite using a commercially supplied catalyst Accent™ 91-5 produced by Johnson Matthey Catalysts company. The catalyst consists of nickel (II) oxide supported on porous Al₂O₃. On the surface of NiO, decomposition of NaClO occurs and atomic oxygen is formed, which further reacts with an organic material to form CO₂. The pH value in the reaction mixture is maintain necessarily at a value of greater than or equal to 8.5, in order to avoid dissolution of the catalyst and release of Ni²⁺ salts into the solution.

The test example was performed using an apparatus composed of a tube flow reactor with a volume of 130 ml, a gas burette with a volume of 100 ml used for measuring the amount of oxygen produced by decomposition of NaOCl, inlet and overflow tubes, tank bottles for brine and sodium hypochlorite, and two peristaltic pumps. A constant temperature was maintained by immersing the reactor in a water bath of the thermostat. The quantity of NaClO necessary for the oxidation of glycerin with sodium hypochlorite was calculated using following equation (I).

7NaOCl+C₃H₈O₃→3CO₂+4H₂O+7Cl⁻ (I)

### Comparative Example 1.1

Brine obtained from the first dehydrochlorination step of the production process for LER was filtered and freed from coarse impurities. This filtered brine with TOC content of 2175 mg/I was treated/alkalinized with a solution of NaOH at concentration of 20% to achieve a pH value of the brine of 8.5-10.5, typically 9.5.

This pre-treated brine was then pumped into a glass column filled with Accent™ 91-5 catalyst, which contains at least 25% of NiO supported on Al₂O₃, at the temperature of 50° C. TOC flow rate was 107 mg/h. Flow rate of NaClO was 12459 mg/h while the consumption of 100% NaClO for the oxidation of TOC was 119 mg/mg. The catalyst load with respect to the TOC flow rate was 446 mg/I*h. The residence time of the reaction mixture was 1.84 h. The final concentration of TOC of the reaction mixture at the outlet of the reactor was 96.4 mg/I and the final concentration of NaCl was 306 g/I.

### Comparative Example 1.2

Brine obtained from the first dechlorination step of the production process for LER was filtered and freed from coarse impurities. Thus filtered brine with TOC content of 2223 mg/I was treated/alkalinized with a solution of NaOH at concentration of 20% to achieve a pH of the brine of 8.5-10.5, typically 9.5. Pre-treated brine was then pumped into a glass column filled with Accent™ 91-5 catalyst, which contains at least 25% of NiO supported on Al₂O₃ at the temperature of 50° C. TOC flow rate was 108 mg/h. Flow rate of NaClO was 13105 mg/h while the consumption of 100% NaOCl for the oxidation of TOC was 121 mg/mg. The catalyst loading by TOC was 270 mg/I·h. The residence time of the reaction mixture was 1.84 h. The final concentration of the TOC of the reaction mixture at the outlet of the reactor was 38.3 mg/I and the final concentration of NaCl was 304 g/I.

The disadvantage of the process according to COMPARATIVE Example 1 and 2 above, where brine is oxidized with sodium hypochlorite using Accent™ 91-5 catalyst, is that there is a high consumption of sodium hypochlorite with surpluses up to 736% above the theoretical consumption and sufficiently low final TOC concentration is not achieved at the outlet of the reactor below 10 mg/I. At the same time, a slow undesirable and unacceptable release of ionic Ni from NiO catalyst occurs. An average concentration of Ni in the effluent at the outlet was 0.026 mg/I while the highest concentration measured was 0.045 mg/I.

Additional test was conducted using two-step arrangement where attempt to reduce the high excess of sodium hypochlorite and necessary reduction of TOC below 10 mg/I was verified. In the two-step arrangement, flow rates of TOC and NaClO were adjusted as described in the examples above. Visible destruction of the catalyst was detected, especially in the second reactor, where fine particles of NiO were drifted to the upper part of the reactor and into the outlet pipe by thick foam formed by the reaction mixture saturated with oxygen. The pH value at the outlet of the second reactor was always above 10, and thus decomposition of NiO was concluded as not being caused by dissolution due to the acidic environment.

### Comparative 2. Photo Accelerated Oxidation

Photo-Fenton oxidation using system of H₂O₂/[Fe^{III}(C₂O₄)₃]³⁻ with UV lamp

### Comparative Example 2.1

The test examples using H₂O₂/[Fe^{III}(C₂O₄)₃]³⁻/UV and H₂O₂/Fe³⁺/UV systems were carried out in the batch arrangement consisting of a tubular reactor with a volume of an irradiated part of 2300 ml, further equipped with a low-pressure discharge lamp with 135 W power and the radiated power of 43 W at a wavelength of 254 nm, with a stirred retention vessel used for homogenization and sampling of the reaction mixture and having a total reaction volume of 4.3 liters.

The quantity of hydrogen peroxide for the reaction of glycerin with hydrogen peroxide was calculated using the following equation (II):

C₃H₈O₃+7H₂O₂→3CO₂+11H₂O (II)

Brine used in following examples obtained from the first dehydrochlorination step of the production process for LER with initial concentration in the range from 2200 to 2400 mg/I was filtered to remove coarse impurities. Thus filtered brine was then acidified with a solution of HCl at concentration of 35% and mixed with the FeCl₃.6H₂O or Na₃[Fe^{III}(C₂O₄)₃] catalyst with an amount of Fe³⁺ ions in the range from 3 to 5 g/I. Finally, a solution of H₂O₂ at concentration of 45% was sequentially and portionally added in an amount which corresponds to 1.15 to 1.5 times of the theoretical consumption.

The reaction proceeded at the temperature of 60° C. and pH value of 2.0 for 7 hours while the TOC and H₂O₂ concentration were continuously monitored. The final content of TOC in the effluent at the outlet was in the range from 25 to 45 mg/I. Specific energy consumption for oxidation of TOC was in the range from 0.093 to 0.100 Wh/mg. A certain drawback of this process was observed, namely formation of various forms of iron in the reaction mixture and also formation of an undesired film containing Fe compounds originated from catalyst on the surface of UV emitters, which led to a decrease of transmittance.

### Comparative 3. Non-Photo Oxidation Followed by Photo-Oxidation

Oxidation of brine with sodium hypochlorite on NiO catalyst followed by Photo-Fenton oxidation using H₂O₂/[Fe^{III}(C₂O₄)₃]³⁻/UV system

Further processes to reduce an organic contamination of concentrated brines which originates in the production process of LER were investigated: e.g. the combination of an oxidation process with sodium hypochlorite using NiO catalyst followed by post-treatment of the effluent at the outlet by Photo-Fenton oxidation using H₂O₂/[Fe^{III}(C₂O₄)₃]³⁻/UV system.

### Comparative Example 3.1

Brine obtained from the first dehydrochlorination step of the production process for LER was, in the first step, subjected to oxidation with sodium hypochlorite using NiO catalyst as described in Example 1.1 above. Thus pre-treated brine with content of TOC of 38 mg/I and concentration of NaCl of 304 mg/I was subjected to Photo-Fenton oxidation carried out in the batchwise arrangement using tubular reactor with a volume of the irradiated part of 2300 ml, further equipped with a low-pressure discharge lamp with 135 W power and the radiated power of 43 W at a wavelength of 254 nm, with a stirred retention vessel for homogenization and sampling of the reaction mixture and having a total reaction volume of 4.3 liters.

After the required acidification using a solution of HCl at concentration of 35%, turbulent decomposition of carbonates formed in the previous alkaline oxidation step was observed. Additionally, a solution of H₂O₂ at concentration of 45% was added in an amount corresponding to 1.5 times of the theoretical consumption according to equation (II). The reaction mixture was homogenized and Na₃[Fe^{III}(C₂O₄)₃] catalyst was added in an amount of Fe³⁺ ions of 5 g/I.

The reaction proceeded at the temperature of 60° C. and pH at the value of about 2.0 for 3 hours, while the TOC and H₂O₂ concentration were continuously monitored. The content of TOC in the effluent at the outlet was in the range from 15 to 17.5 mg/I. Specific energy consumption for oxidation of TOC at the said conditions increased to 4.1 Wh/mg in comparison with the method described in Example 1.2.

A major problem of the Photo-Fenton oxidation process in the case of this brine was high content of carbonates and/or carbon dioxide and oxygen, which were gradually released from the reaction mixture and led to a decrease of transmittance, which was probably the reason for the low conversion of TOC.

### Comparative 4. 2 Step Non Photo Oxidation

Two-step oxidation process using sodium hypochlorite at the temperature of 50-60° C. in a first step and 80-95° C. in the second step

Further processes to reduce the organic content in brines as described in WO2013/144277 is the combination of a first step of vapour stripping for removal of volatile substances from the brine, followed by oxidation with sodium hypochlorite at pH 3.5 to 5 and at the temperature of 50-60° C. and final oxidation with sodium hypochlorite at pH 3 to 4, at the temperature of 80-95° C. The content of COD decreases from the initial amount of 2000 to 4000 mg/I of oxygen down to an amount of 400 to 1500 mg/I of oxygen at the temperature of 50-60° C. After the final oxidation step at elevated temperature, final COD content achieved by this method is not higher than 40 mg/I of oxygen with a chlorate concentration not higher than 0.1 g/I.

The method for the reduction of organic contamination described in WO2013/144227 is focused on the values of COD (chemical oxygen demand) parameters. COD is one of the non-specific indicators of water and its value is used to estimate the organic content of water. The result is converted into oxygen equivalents and is defined in mg/I. The COD parameter has been defined by the amount of oxygen in mg corresponding by stoichiometry to consumption of oxidizing agent to 1 l of water. The chloride content can distort the COD determination. Chlorides are sources of double faults. Chlorides are oxidized to elemental chlorine, thus increasing a consumption of the dichromate. The released chlorine reacts with the organic substances, which either chlorinate, oxidize. Furthermore, the released chlorine can participate in the so called chloro-amine cycle. Such processes distort the results of COD.

The effect of chlorides up to a concentration of 1 g/I can be eliminated by the addition of Mercury (II) Sulfate. When the concentration of the chlorides and the COD is high, the test sample can be controllably diluted to get the final content of chlorides lower than 1 g/I. In the case that the dilution of the sample cannot be used due to already low value of COD and chlorides are present in a higher concentration, it is permitted to conceal the content of chlorides using an amount of Mercury (II) Sulfate higher than the amount indicated in the standard procedure, i.e. use of addition of Mercury (II) Sulfate in amount of 20 mg for the determination of 1 mg of chloride ions in the volume of the sample [1, 2]. Determination without volume correction can be used for wastewater samples with COD in the range from 50 to 700 mg/I. The most accurate results shown by this analytical method provides results of COD in the range from 300 to 600 mg/I. At higher concentrations, it is necessary to use diluted sample [3, 4].

For the analysis of COD in concentrated brines which are virtually saturated solutions of NaCl, above determination is not feasible, as the COD data obtained cannot be taken as relevant, especially such low concentrations of COD and without necessary controlled dilution of the concentration of chlorides, errors in the determination occur. This can be proved by test where glycerin as a standard substance is used and which is also a major source of the organic content of brines originating from the production of LER. For verification, experiments were conducted using glycerin concentration of 250, 350, 500 and 1000 mg/I. The content of NaCl was selected to 160 g/I, i. e. approximately half the concentration of NaCl in industrial brines. Specific value of ThOD (theoretical oxygen demand) for glycerin is 1216 mg/g, a specific TOC of glycerin is 391 mg/g. ThOD:TOC ratio is therefore 3.11. As a comparative method, TOC determination was performed. Results of determination of COD and TOC are presented in the Table 1 below.

The advantage of determining TOC, compared with the COD method, is that complete oxidation of organic compounds by thermal incineration to CO₂ affects a wider spectrum of organic compounds other than COD. All the organic substances in water are expressed indirectly by determination of TOC. This results in conclusion that the evaluation COD and TOC of the same values does not mean the same concentration of organic substances. Only oxygen equivalents are expressed by COD and the carbon concentration by TOC [3].

TABLE 1
COD and TOC determination of glycerin solution

| | | | | COD | | |
|---|---|---|---|---|---|---|
| | | ThOD | TOC | (dilution to | COD (dilution | |
| Glycerin | Chlorides | specific | specific | COD) | to chlorides) | TOC |
| g/l | g/l | mg/g | mg/g | mg/l | mg/l | mg/l |
| 1.0 | 97.1 | 1216 | 391 | 1210 | 1235 | 390 |
| 0.5 | 97.1 | 608 | 196 | opacity | 670 | 200 |
| 0.35 | 97.1 | 426 | 137 | opacity | 620 | 135 |
| 0.25 | 97.1 | 304 | 98 | opacity | 225 | 95.8 |
| 0.1 | 97.1 | 122 | 39 | red/brown | 560 | 40.2 |
| | | | | colouring | | |
| | | | | before | | |
| | | | | titration | | |

Results presented in the Table 1 demonstrate that already at NaCl concentration of 160 g/I and with dilution to COD, opacity occurs during determination. When COD is done on diluted chlorides, there is a significant deflection compared with estimated amount of ThOD for glycerin. On the other hand, there is only a minor deflection when TOC is determined for concentration of glycerin. The method of COD determination was performed according to ISO 6060 standard. The method of determination of TOC was performed according to CSN EN 1484 standard.

The requirement for the TOC content in industrial brines, when utilized in the chlor-alkali membrane electrolysis technology, is very strict and has to be less than 10 mg/I.

### Comparative Example 4.1

Brine from the first dehydrochlorination step of the production process for LER with TOC concentration of 2500 mg/I and concentration of NaCl higher than 290 g/I was used in the Example 4.1.

Filtration was used for removal of resinous emulsions from brine.

Firstly, the brine was treated/acidified using concentrated solution of HCl to achieve a pH value of the brine lower than 2. Brine was then pumped through the glass spiral type heat exchanger into a tube flow reactor, where sodium hypochlorite at 1.1 to 1.5 times the theoretical consumption of sodium hypochlorite required to oxidize TOC of glycerin according to equation (I) was added.

Chemical oxidation with sodium hypochlorite was carried out at atmospheric pressure and the temperature of 55-60° C. An average flow rate of brine was 1.36 l/h and an average flow rate of sodium hypochlorite was 58.89 g/h. Residence time of the reaction mixture in the reactor was 1.33 hours. The content of TOC decreases to an average amount of 433 mg/I.

The pH value of the reaction mixture at the outlet was in the range from 3.7 to 5.4 and the concentration of residual sodium hypochlorite in the effluent at the outlet was in the range from 600 to 800 mg/I. An average amount of reduced TOC was 3400 mg/h. An average amount of initial TOC including dilution factor of the brine with sodium hypochlorite at the inlet was 1960 mg/I. The content of reduced TOC of diluted brine was calculated to amount of 2666 mg/h.

Residual content of sodium hypochlorite in the reaction mixture was further reduced using hydrogen peroxide. Stoichiometric amount was calculated using the equation (II). Hydrogen peroxide was fed by a single dose. The reaction mixture was stirred using an overhead stirrer.

Thus treated reaction mixture was then subjected to a final oxidation with sodium hypochlorite at the temperature in the range 80-95° C.

The reaction mixture was pumped into the glass tube flow reactor with double-jacket, which function to maintain the desired temperature in the reactor. Simultaneously, the reactor was fed with sodium hypochlorite dosed at 4 times of the theoretical consumption of sodium hypochlorite required to oxidize TOC of glycerin according to equation (I).

The oxidation with sodium hypochlorite was carried out at atmospheric pressure and an elevated temperature. An average flow rate of the reaction mixture was 0.269 l/h and an average flow rate of sodium hypochlorite was 6 g/h. Residence time of the reaction mixture in the reactor was 1.95 h. The content of TOC of brine was reduced to an average amount of 63.7 mg/I.

The pH value of the reaction mixture after the oxidation at elevated temperatures was at the outlet in the range from 3 to 4.5, the concentration of residual sodium hypochlorite was at the outlet in the range from 2 to 2.38 g/I.

An average amount of reduced TOC was 99 mg/h. Concentration of chlorates at the outlet was in the range from 7 to 9 g/I.

Efficiency of Oxidation at the Temperature of 80-95° C. for Various Concentrations of TOC

In order to verify the efficiency of the oxidation step at elevated temperatures between 80-95° C., several example tests were carried out for various starting concentrations of TOC in the reaction mixture obtained from the first step of the photochemical oxidation using UV/NaClO according to method as shown below.

### Comparative Example 4.2

Reaction mixture with content of TOC of 82 mg/I was used in this Example 4.2.

The reaction mixture was pumped into the glass tube flow reactor with double-jacket, which function to maintain the desired temperature in the reactor. Simultaneously, the reactor was fed with sodium hypochlorite dosed at 4 times of the theoretical consumption of sodium hypochlorite required to oxidize TOC of glycerin according to equation (I).

The oxidation with sodium hypochlorite was carried out at atmospheric pressure and an elevated temperature. An average flow rate of the reaction mixture was 0.316 l/h and an average flow rate of sodium hypochlorite of 1.48 g/h. Residence time of the reaction mixture in the reactor was 1.84 h. The content of TOC of brine was reduced to an average value of 44 mg/I.

The pH value of the reaction mixture after oxidation at elevated temperature was at the outlet in the range from 3 to 5.1, the concentration of residual sodium hypochlorite was at the outlet in the range from 110 to 560 mg/I.

An average amount of reduced TOC was 12 mg/h. The content of chlorates was at the outlet in the range from 7 to 9 g/I.

### Comparative Example 4.3

Reaction mixture with content of TOC of 150 mg/I was used in this Example 4.3.

The reaction mixture was pumped into the glass tube flow reactor with double-jacket, which function to maintain the desired temperature in the reactor. Simultaneously, the reactor was fed with sodium hypochlorite dosed at 4 times of the theoretical consumption of sodium hypochlorite required to oxidize TOC of glycerin according to equation (I).

The oxidation with sodium hypochlorite was carried out at atmospheric pressure and an elevated temperature. An average flow rate of the reaction mixture was 0.338 l/h and an average flow rate of sodium hypochlorite was 2.6 g/h. Residence time of the reaction mixture in the reactor was 1.7 h. The content of TOC of brine was reduced to an average amount of 51.4 mg/I.

The pH value of the reaction mixture after oxidation at elevated temperature was at the outlet in the range from 3 to 5.1, the concentration of residual sodium hypochlorite at the outlet was in the range from 110 to 300 mg/I.

An average value of reduced TOC was 31 mg/h. The content of chlorates was at the outlet in the range from 7 to 9 g/I.

As can be seen in Examples 4.2 and 4.3, it is not possible to reach such results of COD content which is lower than 40 mg/I of oxygen as discussed above using process of oxidation at elevated temperature of 80-95° C. The lowest average amount of TOC measured was 44 mg/I. Additionally, it was observed that using such method increases the concentration of chlorates of at least 100%, compared with methods of a photochemical oxidation in the first and second step including also oxidation at 60° C.

### Comparative 5. Photo Oxidation Process. Single Step

Process of Photooxidation Using UV/NaClO and H₂O₂/[Fe^{III}(C₂O₄)3]³⁻/UV Systems

### Comparative Example 5.1

Brine from the first dehydrochlorination step of the production process for LER with content of TOC in the range from 1500 to 2500 mg/I and concentration of NaCl higher than 290 g/I was used in the Example 5.1.

Filtration was used for removal of resinous emulsions from brine.

Continuous flow apparatus consisting of quartz reactor with irradiated volume of 2300 ml having centrally positioned immersion emitter of 135 W of power and 43 W of radiated power at a wavelength of 254 nm. Brine was fed from the tank via the glass spiral type heat exchanger into the inlet located in the upper part of the reactor. Reaction mixture from the outlet in the bottom part of the reactor was return back via first separated line to the upper part of the reactor. Part of the reaction mixture was also fed upwards into the level of the upper inlet in the reactor using second separated line and then was discharged into the collecting tank. The temperature of the reaction mixture was measured at the inlet and the outlet of the reactor.

Further, sodium hypochloride or catalyst was also fed at the inlet into the reactor.

An amount of NaClO used for the oxidation of glycerin GLY with sodium hypochlorite was calculated using the equation (I). NaClO dosage was set to consumption of, at most, 1.5 times the theoretical consumption.

The quantity of hydrogen peroxide for the reaction of glycerin GLY with hydrogen peroxide was calculated using the following equation (II):

C₃H₈O₃+7H₂O₂→3CO₂+11H₂O (II)

which indicates that for oxidation of 1 mg TOC of glycerin GLY, 6.61 mg of H₂O₂ with the concentration of 100% is needed. The dosage of hydrogen peroxide was set to consumption of 5 times the theoretical consumption.

Brine was treated at the inlet of the reactor using solution of HCl at concentration of 35% to achieve a pH value of the brine equal or lower to 2. Both emitter and thermostat were switched on and acidified brine with sodium hypochlorite was pumped into the reactor. The flow rate of the reaction mixture was about 0.749 I. The mean residence time of the reactor was 3.6 h. The concentration of TOC at the outlet was in the range from 55.7 to 130.7 mg/I at pH value in the range from 4 to 6.3 with content of NaClO lower than 300 mg/I at the temperature of 55-60° C.

Residual content of sodium hypochlorite in the reaction mixture was further reduced using hydrogen peroxide. Stoichiometric amount of hydrogen peroxide dosed was calculated according to equation (III):

NaClO+H₂O₂→O₂+NaCl+H₂O (III)

The reaction mixture was further treated at the inlet of the reactor using solution of HCl at concentration of 35% to achieve a pH value of the brine equal or lower than 3 and was further subjected to Photo-Fenton oxidation using H₂O₂/[Fe^{III}(C₂O₄)₃]³⁻/UV system. Both emitter and thermostat were switched on and acidified brine, hydrogen peroxide and Na₃[Fe^{III}(C₂O₄)₃] catalyst were fed into the reactor. The flow rate of the reaction mixture was about 0.684 I. The mean residence time of the reactor was 3.5 h. The concentration of TOC at the outlet was in the range from 10.8 to 47.2 mg/I at pH 4 to 5.8 and at the temperature of 55-60° C.

The problem of using this combined process is increased formation of bubbles in the reactor during the Photo-Fenton oxidation and the formation of opacity at the outlet with increased concentration of iron in the range from 0.332 to 0.732 mg/I. ART: https://www.ncbi.nlm.nih.gov/pubmed/16393899

“In this study, the photochemical degradation of livestock wastewater was carried out by the Fenton and Photo-Fenton processes. The effects of pH, reaction time, the molar ratio of Fe²⁺/H₂O₂, and the Fe²⁺ dose were studied. The optimal conditions for the Fenton and Photo-Fenton processes were found to be at a pH of 4 and 5, an Fe²⁺ dose of 0.066 M and 0.01 M, a concentration of hydrogen peroxide of 0.2 M and 0.1 M, and a molar ratio Fe²⁺/H₂O₂ of 0.33 and 0.1, respectively. The optimal reaction times in the Fenton and Photo-Fenton processes were 60 min and 80 min, respectively. Under the optimal conditions of the Fenton and Photo-Fenton processes, the chemical oxygen demand (COD), color, and fecal coliform removal efficiencies were approximately 70-79, 70-85 and 96.0-99.4%, respectively.”

### Invention Examples 6. Two Step System

Processes Using Step a) Systems of UV/NaClO and UV/NaClO with a Step b) Using Ionex-Adsorption (INVENTION)

The present invention relates to a process for selective reduction of organic carbon in brines originating from the first dehydrochlorination step of the production for LER to achieve a final total organic carbon TOC content of less than 10 mg/I.

These brines thus are streams of waste waters with high concentration of both TOC and NaCl. The content of TOC is in the range from 2000 to 3600 mg/I and NaCl is present in amount of more than 290 g/I. Glycerin GLY as a main component of TOC is present in the range from 0.37 to 3.5 g/I.

The content of TOC in the brine is progressively reduced in several steps, all of which are conducted at relatively moderate temperatures and reaction conditions to prevent formation of undesired chlorates and to achieve the desired reduction of TOC content to less than 10 mg/I, while maintaining a high concentration of NaCl, so that the resultant purified brine can be recycled and further use in chlor-alkali membrane electrolysis process.

If the brine originating from the production of LER contains resinous emulsions, it is necessary to remove these emulsions using filtration before starting the experiment.

The following steps are used: These are of step a) type:

Step a1): the acidified brine is subjected to photochemical oxidation using NaClO under UV lamp at the temperature in the range of 55-62° C. and UV radiation at a wavelength of from 200 nm to 600 nm.

The final content of TOC in the reaction mixture at the outlet is less than 350 mg/I.

Step a2) follows the step a1): The treated brine from step a1) is re-acidified using a solution of HCl and is subjected to a second step of photochemical oxidation using NaClO under UV lamp at the temperature in the range of 55-62° C. and UV-C radiation at a wavelength of from 200 nm to 600 nm.

After the second step of photochemical oxidation, the final content of TOC in the reaction mixture at the outlet is less than 100 mg/I.

Residual sodium hypochlorite in the reaction mixture maybe further reduced in additional intermediate stage using e.g. hydrogen peroxide.

STEP b): The treated brine from Step 2 is re-acidified using a solution of HCl and then subjected to further purification using a column filled with Lewatit® AF5 ion exchange resin.

The content of TOC in the reaction mixture after purification using an ion exchanger is less than 10 mg/I.

When using a process of photochemical oxidation to remove content of TOC, there is formation of radicals, which also function as oxidizing agents and this further aids the oxidation with sodium hypochlorite, so that minimum sodium hypochlorite needs to be used.

The amount of sodium hypochlorite is dosed at 1.0 to 1.5 times the stoichiometric ratio of sodium hypochlorite required to oxidize glycerin according to following equation (I):

7NaOCl+C₃H₈O₃→3CO₂+4H₂O+7Cl⁻ (I)

which shows that, theoretically, for oxidation of 1 g TOC originated from glycerin, 14.476 g of NaClO with the concentration of 100% is needed.

In the case of hydrogen peroxide as the oxidising agent, the amount of hydrogen peroxide used for the reduction of residual sodium hypochlorite in the reaction mixture is dosed in the stoichiometric amount according to following equation (III):

NaClO+H₂O₂=O₂+NaCl+H₂O (III)

which shows that for removal of 1 mg of NaClO, 0.457 mg of H₂O₂ with the concentration of 100% is needed.

Brine was treated using solution of HCl to achieve a pH value lower than 2 before STEP a) photochemical oxidation was performed. The pH value at the outlet from the reactor was not higher than 7.5, typically not higher than 6.5.

The partially degraded waste water reaction mixture from the step a1) was treated again using a solution of HCl to achieve a pH lower than 2, before the step a2) of the photochemical oxidation. The pH value at the outlet from the reactor was not higher than 7.5, typically not higher than 6.5.

This waste water reaction mixture from the step a2), was re-acidified using a solution of HCl to achieve a pH lower than 3.5, before subjecting to the STEP b) aftertreatment, which is the purification step using a physical absorber, e.g. an ion exchange microporous resin, e.g. Lewatit® AF-5.

The pH at the outlet from such after treatment step was not higher than 10, so that the raised from 3.5 to 10 during performing this after treatment.

Washing and regeneration of the ion exchange column is carried out using hot demineralised water or steam. Waste water from the washing and regeneration of ion exchangers can be further treated by recycling back to the STEP a) of present invention or in the biological wastewater treatment plant or other appropriate treatment.

### Inventive Example 6.1

Example tests were conducted using brine having resinous emulsions and originating from the first dehydrochlorination step of the production process for LER with concentration of NaCl higher than 290 g/I and a TOC content of 2500 mg/I.

A vacuum filtration was used to remove resinous emulsions from the brine using filtration crucible with integrated polypropylene filter plate with porosity of 10 μm.

STEP a): the brine was treated/acidified using concentrated HCl to achieve a pH value less than 2. This acidified brine was then pumped via the glass spiral type heat exchanger into the tube flow reactor with a centrally positioned UV Hg low pressure lamp.

Sodium hypochlorite solution was dosed into the tube flow reactor at 1.1 to 1.5 times the theoretical consumption of sodium hypochlorite required to oxidize TOC of glycerin according to equation (I).

Photochemical oxidation using UV/NaClO system was carried out at atmospheric pressure and at the temperature of 55-62° C. using UV-C radiation at wavelength of about 254 nm.

An average flow rate of brine was 1.77 l/h, an initial content of TOC in brine at the inlet of STEP a) was 2500 mg/I, an average flow rate of sodium hypochlorite was 70.96 g/h and the residence time of the reaction mixture in the reactor was 1.03 h. The content of TOC decreases to an average amount of 190 mg/I.

An average amount of reduced content of TOC was 4089 mg/h which corresponds to the specific energy consumption of 0.0330 Wh/mg. An average amount of initial TOC including dilution factor of the brine with sodium hypochlorite was at the inlet 1975 mg/I. The content of reduced TOC of diluted brine was calculated to an amount of 3159 mg/h which corresponds to the specific energy consumption 0.0427 Wh/mg.

The pH value of the reaction mixture at the outlet was in the range from 4.5 to less than 7.0 and the concentration of residual sodium hypochlorite at the outlet was less than 200 mg/I.

The output from above step a1) was treated with hydrogen peroxide to reduce residual content of sodium hypochlorite in the reaction mixture from the above step a1).

Stoichiometric amount of hydrogen peroxide to be used was calculated according to equation (III).

Such continuously treated reaction mixture from step a1) was then subjected to additional/repeated STEP a) photochemical oxidation using UV/NaClO system under the conditions discussed above in step a1) of this Example.

Step a2) photochemical oxidation using UV/NaClO system was carried out under following conditions: an average flow rate of the reaction mixture was 1.65 l/h, a content of TOC in the reaction mixture at the inlet was 190 mg/I, an average flow rate of sodium hypochlorite was 7.04 g/h, the residence time of the reaction mixture in the reactor was 1.35 h while the average content of TOC at the outlet was 34 mg/I.

An average amount of the content of TOC reduced during the step a2) photochemical oxidation was 258 mg/h which corresponds to the specific energy consumption of 0.523 Wh/mg. An average amount of initial TOC including dilution factor of the brine with sodium hypochlorite was at the inlet 185 mg/I. The content of reduced TOC of diluted brine was calculated to amount of 249 mg/h which corresponds to the specific energy consumption 0.542 Wh/mg.

The pH value of the reaction mixture at the outlet from step a2) photochemical oxidation was in the range from 5 to 6.5 and the concentration of residual sodium hypochlorite at the outlet was less than 70 mg/I.

Residual content of sodium hypochlorite in the reaction mixture was further reduced using hydrogen peroxide. Stoichiometric amount was calculated according to equation (III). Hydrogen peroxide was added by a single dose. The reaction mixture was stirred using an overhead stirrer.

STEP b: the reaction mixture with an average amount of TOC of 34 mg/I was further treated/acidified using concentrated HCl to achieve a pH value lower than 3.5 and further subjected to post-treatment by means of the absorber Lewatit® AF5 microporous ion exchange resin by feeding acidified reaction mixture into the glass flow column filled with ion exchanger.

The flow rate of the reaction mixture was set up to 5.8 BV/h. The average concentration of TOC at the outlet was 6.14 mg/I. The pH value was in the range of 5 to 9.5 and concentration of chlorates at the outlet was less than 0.1 g/I.

Efficiency of reduction of the content of TOC in the step a1) of photochemical oxidation using NaClO with UV lamp

In order to verify the efficiency of the reduction of TOC content in first STEP 1a) photochemical oxidation using UV/NaClO system, several example tests were carried out for various initial concentrations of TOC, flow rates of brine, residence time of the reaction mixture in the reactor as shown in Examples 5.1 and 6.1 above.

### Inventive Example 6.2

STEP a): the photochemical oxidation with NaClO and UV lamp was carried out using brine originating from the first dehydrochlorination step of the production for LER with concentration of NaCl more than 290 g/I and TOC content of 2700 mg/I.

Example 6.2 was performed according Step a) as described in the Example 6.1 above, under following conditions: an average flow rate of brine was 0.927 l/h, an average flow rate of sodium hypochlorite was 40.48 g/h, the residence time of the reaction mixture in the reactor was 1.33 h and the content of TOC was reduced to an average amount of 162 mg/I.

The average amount of reduced content of TOC was 2353 mg/h which corresponds to the specific energy consumption of 0.0574 Wh/mg. The average amount of TOC including dilution factor of the brine with sodium hypochlorite was at the inlet 1882 mg/I. The content of reduced TOC of diluted brine was calculated to an amount of 1594 mg/h which corresponds to the specific energy consumption of 0.0847 Wh/mg.

The pH value of the reaction mixture at the outlet was in the range from 4.5 to 7.0 and the concentration of residual sodium hypochlorite at the outlet was less than 200 mg/I.

### Inventive Example 6.3

Example 6.3 was performed according to the process described in example 6.1, where only the Step a) were changed, with step b) remaining the same.

STEP a): photochemical oxidation with NaClO and UV lamp was carried out using brine originating from the first dehydrochlorination step of the production for LER with concentration of NaCl of more than 290 g/I and TOC content of 2400 mg/I.

Example 6.3 was performed according to Step 1 as described in the Example 6.1 above, under following conditions: an average flow rate of brine was 1.063 l/h, an average flow rate of sodium hypochlorite was 41.39 g/h, the residence time of the reaction mixture in the reactor was 1.32 h and the content of TOC was reduced to an average amount of 138 mg/I.

The average amount of reduced TOC content was 2405 mg/h which corresponds to the specific energy consumption of 0.0561 Wh/mg. The average amount of TOC including dilution factor of the brine with sodium hypochlorite was at the inlet 1933 mg/I. The content of reduced TOC of diluted brine was calculated to an amount of 1908 mg/h which corresponds to the specific energy consumption of 0.0708 Wh/mg.

The pH value of the reaction mixture at the outlet was in the range from 4.5 to 7.0 and the concentration of residual sodium hypochlorite at the outlet was less than 200 mg/I.

This was treated as in Step b) of example 6.1.

### Inventive Example 6.4

STEP a): the photochemical oxidation with NaClO and UV lamp was carried out using brine originating from the first dehydrochlorination step of the production for LER with concentration of NaCl of more than 290 g/I and TOC content of 3130 mg/I.

Example 6.3 was performed according to Step a) as described in the Example 6.1 above, under following conditions: an average flow rate of brine was 1.99 l/h, an average flow rate of sodium hypochlorite was 74.779 g/h, the residence time of the reaction mixture in the reactor was 0.95 h and the content of TOC was reduced to an average amount of 357 mg/I.

The average amount of reduced TOC content was 5518 mg/h which corresponds to the specific energy consumption of 0.0245 Wh/mg. The average amount of TOC including dilution factor of the brine with sodium hypochlorite was at the inlet 4390 mg/I. The content of reduced TOC of diluted brine was calculated to an amount of 1908 mg/h which corresponds to the specific energy consumption of 0.0308 Wh/mg. The pH value of the reaction mixture at the outlet was in the range from 4.5 to 7.0 and the concentration of residual sodium hypochlorite at the outlet was less than 200 mg/I.

This was then treated as in Step b) of example 6.1.

TABLE 2
Comparison of results - Examples according to present invention

| | | | | | | | | | | | | | |
|---|---|---|---|---|---|---|---|---|---|---|---|---|---|
| | | Temper- | | | pH | | | | Average | | Concen- | Average | NaOCl |
| | | ature | pH of | Initial | of | Final | | | flow | Specific | tration | flow | concen- |
| | Emitter | in the | initial | TOC | final | TOC | TOC | Δ | rate of | energy | of NaClO | rate of | tration at |
| | power | reactor | brine | (inlet) | brine | (outlet) | reduced | TOC | brine | consumption | feedstock | NaClO | the outlet |
| Example | W | ° C. | — | mg/l | — | mg/l | mg/h | % | l/h | Wh/mg | g/l | g/h | g/l |

Step a1): photochemical oxidation with UV/NaClO system

| | | | | | | | | | | | | | |
|---|---|---|---|---|---|---|---|---|---|---|---|---|---|
| 6.1 | 135 | 55-62 | <2.0 | 2 500 | 4.5- | 190 | 3 159 | 90.38 | 1.770 | 0.0427 | 151 | 70.96 | <0.200 |
| | | | | | 7.0 | | | | | | | | |
| 6.2 | 135 | 55-60 | <2.0 | 2 700 | 4.5- | 162 | 1 594 | 91.39 | 0.927 | 0.0847 | 153 | 40.48 | <0.200 |
| | | | | | 7.0 | | | | | | | | |
| 6.3 | 135 | 57-61 | <2.0 | 2 400 | 4.5- | 138 | 1 908 | 92.86 | 1.063 | 0.0708 | 164 | 41.39 | <0.200 |
| | | | | | 7.0 | | | | | | | | |
| 6.4 | 135 | 60-62 | <2.0 | 3 130 | 4.5- | 357 | 4 309 | 86.07 | 1.990 | 0.0308 | 176 | 74.779 | <0.200 |
| | | | | | 7.0 | | | | | | | | |

Step a2) : photochemical oxidation with UV/NaClO systEm

| | | | | | | | | | | | | | |
|---|---|---|---|---|---|---|---|---|---|---|---|---|---|
| 6.1 | 135 | 57-61 | <2.0 | 190 | 5.0- | 34 | 249 | 81.56 | 1.650 | 0.542 | 153 | 7.04 | <0.070 |
| | | | | | 6.5 | | | | | | | | |

Step b: ion exchange resin purification

| | | | | ClO₃⁻ concentration at | |
|---|---|---|---|---|---|
| | Initial TOC of brine | Final TOC of brine | Specific flow rate | the outlet | pH at the outlet |
| Example | mg/l | mg/l | BV/h | g/l | — |
| 6.1 | 34 | 6.14 | 5.8 | <0.1 | 5.0 - 9.5 |

### Example 7. Comparing the Efficiency of UV/NaClO System to the Oxidation with NaClO with No UV, Both at 60° C.

ONLY STEP a) is compared to investigate how much TOC is removed with and without UV during the photo oxidation step a).

In order to verify the efficiency of the photochemical oxidation using UV/NaClO system in comparison with oxidation with only sodium hypochlorite, and no UV, at a temperature of 55-62° C., example test was carried out in which, firstly, a steady state of the photochemical oxidation using UV/NaClO system was achieved, UV-C emitter was then switched off and the experiment was further performed using mere oxidation with sodium hypochlorite, as shown in Examples 6.2 and 6.3 above.

### Inventive Example 7.1

STEP a): the photochemical oxidation was conducted as described in 6.2 and was carried out using brine originating from the first dehydrochlorination step of the production for LER with concentration of NaCl of more than 290 g/I and TOC content of 2500 mg/I.

Example 7.1 was performed according to Step a) as described in the Example 6.1 above, under following conditions: an average flow rate of brine was 1.535 l/h, an average flow rate of sodium hypochlorite was 56.94 g/h, the residence time of the reaction mixture in the reactor was 1.21 h and the content of TOC was reduced to an average amount of 206 mg/I.

The average amount of reduced TOC content was 3522 mg/h which corresponds to the specific energy consumption of 0.0383 Wh/mg. The average amount of TOC including dilution factor of the brine with sodium hypochlorite was at the inlet 2020 mg/I. The content of reduced TOC of diluted brine was calculated to an amount of 2785 mg/h which corresponds to the specific energy consumption of 0.0485 Wh/mg. The pH value of the reaction mixture at the outlet was in the range from 4.5 to 6.35 and the concentration of residual sodium hypochlorite at the outlet was less than 200 mg/I.

This was then treated as in Step b) of example 6.1.

### Inventive Example 7.2

STEP 1: the test was carried out using brine originating from the first dehydrochlorination step of the production for LER with concentration of NaCl of more than 290 g/I and TOC content of 2500 mg/I.

Example 7.2 was performed according to Step a) as described in the Example 6.1 above and was carried out under following conditions: an average flow rate of brine was 1.8 l/h, an average flow rate of sodium hypochlorite was 64.65 g/h, the residence time of the reaction mixture in the reactor was 1.03 h and the content of TOC was reduced to an average amount of 255 mg/I.

The average amount of reduced TOC content was 4063 mg/h which corresponds to the specific energy consumption of 0.0332 Wh/mg. The average amount of TOC including dilution factor of the brine with sodium hypochlorite was at the inlet 2025 mg/I. The content of reduced TOC of diluted brine was calculated to an amount of 3204 mg/h, which corresponds to the specific energy consumption of 0.0421 Wh/mg. The pH value of the reaction mixture at the outlet was in the range from 4.5 to 7.0 and the concentration of residual sodium hypochlorite at the outlet was less than 200 mg/I.

This was then treated as in Step b) of example 6.1.

### Comparative Example 7.3

COMPARATIVE TO STEP a) of the Example 7.1: The UV-C emitter was then disconnected and only oxidation with sodium hypochlorite proceeded at an average flow rate of brine 1.43 l/h, an average flow rate of sodium hypochlorite 50.68 g/h, a residence time of the reaction mixture in the reactor of 1.3 h and thus the TOC was reduced to an average amount of 543 mg/I.

The average amount of reduced TOC content using an oxidation with sodium hypochlorite was 2655 mg/h. The average amount of TOC including dilution factor of the brine with sodium hypochlorite at the inlet was 1950 mg/I. The content of reduced TOC of diluted brine was calculated to an amount of 2012 mg/h.

The pH value of the reaction mixture at the outlet was in the range from 5.8 to 6.8 and the concentration of residual sodium hypochlorite at the outlet was less than 500 mg/I.

Decrease of efficiency in reduction of TOC content of 773 mg/h was observed after the UV-C emitter was disconnected.

The reactor temperature was maintained in the range of 55−62° C. throughout whole experiment.

### Comparative Example 7.4

COMPARATIVE TO STEP a) of the Example 7.2: The UV-C emitter was then disconnected and only oxidation with sodium hypochlorite proceeded at an average flow rate of brine 1.65 l/h, an average flow rate of sodium hypochlorite 50.87 g/h, a residence time of the reaction mixture in the reactor of 1.16 h and thus the TOC was reduced to an average amount of 574 mg/I.

The average amount of reduced content of TOC using an oxidation with sodium hypochlorite was 3118 mg/h. The average amount of TOC including dilution factor of the brine with sodium hypochlorite was at the inlet 2078 mg/I. The content of reduced TOC of diluted brine was calculated to an amount of 2482 mg/h.

The pH value of the reaction mixture at the outlet was in the range from 4.5 to 7.0 and the concentration of residual sodium hypochlorite at the outlet was less than 500 mg/I.

Decrease of efficiency in reduction of TOC content of 722 mg/h was observed, after the UV-C emitter was disconnected.

The reactor temperature was maintained in the range of 55-62° C. throughout whole experiment.

TABLE 3
Comparison of results

| | | | | | | | | | | | | | |
|---|---|---|---|---|---|---|---|---|---|---|---|---|---|
| | | Temper- | | | | Final | | | | | Concen- | Average | NaOCl |
| | | ature | pH of | Initial | pH of | TOC at | | | Average | Specific | tration | flow rate | concen- |
| | Emitter | in the | initial | TOC | final | the | TOC | Δ | flow rate | energy | of NaClO | of | tration at |
| | power | reactor | brine | (inlet) | brine | outlet | reduced | TOC | of brine | consumption | feedstock | NaClO | the outlet |
| Example | W | ° C. | — | mg/l | — | mg/l | mg/h | % | l/h | Wh/mg | g/l | g/h | g/l |

Step 1 photochemical oxidation with UV/NaClO system

| | | | | | | | | | | | | | |
|---|---|---|---|---|---|---|---|---|---|---|---|---|---|
| 7.1 | 135 | 55-62 | <2.0 | 2 500 | 4.5- | 206 | 2 785 | 89.20 | 1.535 | 0.0485 | 153 | 56.94 | <0.200 |
| Inventive | | | | | 6.35 | | | | | | | | |
| 7.2 | 135 | 55-62 | <2.0 | 2 500 | 4.5-7.0 | 255 | 3 204 | 87.41 | 1.8 | 0.0421 | 153 | 64.65 | <0.200 |
| Inventive | | | | | | | | | | | | | |

Step 1 oxidation with NaClO only

| | | | | | | | | | | | | | |
|---|---|---|---|---|---|---|---|---|---|---|---|---|---|
| 7.3 | — | 55-62 | <2.0 | 2 500 | 5.8-6.8 | 543 | 2 012 | 72.15 | 1.43 | — | 153 | 50.68 | <0.500 |
| Comparative | | | | | | | | | | | | | |
| 7.4 | — | 55-62 | <2.0 | 2 500 | 4.5-7.0 | 574 | 2 482 | 72.38 | 1.65 | — | 153 | 50.87 | <0.500 |
| Comparative | | | | | | | | | | | | | |

### Comparative Example 8. A Comparison of Efficiency of TOC Reduction in Step a) Photochemical Oxidation Using Low-Pressure Hg Lamp, High-Pressure Hg Lamp and an Oxidation without UV Lamp

In order to verify the efficiency of the reduction of TOC content in Step a) photochemical oxidation, several example tests were carried out using low-pressure Hg-lamp (Example 8.1), high-pressure Hg lamp (Example 8.2) and mere oxidation using NaClO without UV lamp (Example 8.3). Reactor itself was protected against the daylight/ambient light coming from outside.

### Inventive Example 8.1

STEP a): photochemical oxidation with NaClO and UV lamp was carried out using brine originating from the first dehydrochlorination step of the production for LER with concentration of NaCl of more than 290 g/I and TOC content of 3690 mg/I.

Filtration was used for removal of resinous emulsions from brine.

Firstly, brine was acidified using concentrated solution of HCl to achieve a pH value of the brine lower than 2. Brine was then pumped through the glass spiral type heat exchanger into a tube flow reactor having centrally positioned low-pressure emitter. Sodium hypochlorite was dosed into the tube flow reactor at 1.1 to 1.5 times the theoretical consumption of sodium hypochlorite required to oxidize TOC of glycerin according to equation (I).

Photochemical oxidation with UV/NaClO system was carried out at atmospheric pressure and the temperature of 55-62° C. using low-pressure Hg lamp with 135 W power.

Example test was performed at an average flow rate of brine 2.5 l/h, an average flow rate of sodium hypochlorite 125 g/h, a residence time of the reaction mixture in the reactor 0.70 h and the final content of TOC was reduced to an average amount of 364 mg/I.

The average amount of reduced content of TOC was 8315 mg/h which corresponds to the specific energy consumption of 0.01624 Wh/mg. The average amount of TOC including dilution factor of the brine with sodium hypochlorite at the inlet was 2813 mg/I. The content of reduced TOC of diluted brine was calculated to an amount of 6123 mg/h which corresponds to the specific energy consumption of 0.0220 Wh/mg. The pH value of the reaction mixture at the outlet was in the range from 4.5 to 7.0 and the concentration of residual sodium hypochlorite at the outlet was less than 200 mg/I.

### Inventive Example 8.2

STEP a): photochemical oxidation with NaClO and UV lamp was carried out using brine originating from the first dehydrochlorination step of the production for LER with concentration of NaCl of more than 290 g/I and TOC content of 3690 mg/I.

Filtration was used for removal of resinous emulsions from brine.

Firstly, brine was acidified using concentrated solution of HCl to achieve a pH value of the brine lower than 2. Brine was then pumped through the glass spiral type heat exchanger into a tube flow reactor having centrally positioned high-pressure emitter. Sodium hypochlorite was dosed into the tube flow reactor at 1.1 to 1.5 times the theoretical consumption of sodium hypochlorite required to oxidize TOC of glycerin according to equation (I).

Photochemical oxidation with UV/NaClO system was carried out at atmospheric pressure and at the temperature of 55-62° C. using high-pressure Hg lamp with 135 W power.

Example test was performed at an average flow rate of brine 2.6 l/h, an average flow rate of sodium hypochlorite 121 g/h, a residence time of the reaction mixture in the reactor 0.70 h and the content of TOC was reduced to an average amount of 385 mg/I.

The average amount of reduced content of TOC was 8593 mg/h which corresponds to the specific energy consumption of 0.01571 Wh/mg. The average amount of TOC including dilution factor of the brine with sodium hypochlorite at the inlet was 2881 mg/I. The content of reduced TOC of diluted brine was calculated to an amount of 6490 mg/h which corresponds to the specific energy consumption of 0.0193 Wh/mg. The pH value of the reaction mixture at the outlet was in the range from 4.5 to 7.0 and the concentration of residual sodium hypochlorite at the outlet was less than 200 mg/I.

### Inventive Example 8.3

STEP a): An oxidation with sodium hypochlorite was carried out using brine originating from the first dehydrochlorination step of the production for LER with concentration of NaCl of more than 290 g/I and TOC content of 3380 mg/I. Filtration was used for removal of resinous emulsions from brine.

Firstly, brine was acidified using concentrated solution of HCl to achieve a pH value of the brine lower than 2. Brine was then pumped through the glass spiral type heat exchanger into the tube flow reactor.

Sodium hypochlorite was dosed into the tube flow reactor at 1.1 to 1.5 times the theoretical consumption of sodium hypochlorite required to oxidize TOC of glycerin according to equation (I).

An oxidation with sodium hypochlorite was carried out at atmospheric pressure and at the temperature of 55-62° C.

Example test was performed at an average flow rate of brine 2.54 l/h, an average flow rate of sodium hypochlorite 87.4 g/h, a residence time of the reaction mixture in the reactor 0.75 h and the content of TOC was reduced to an average amount of 810 mg/I.

The average amount of reduced content of TOC by oxidation with sodium hypochlorite was 6528 mg/h. The average amount of TOC including dilution factor of the brine with sodium hypochlorite at the inlet was 2801 mg/I. The content of reduced TOC of diluted brine was calculated to an amount of 5057 mg/h.

The pH value of the reaction mixture at the outlet was in the range from 4.5 to 7.0 and the concentration of residual sodium hypochlorite at the outlet was less than 700 mg/I.

An example test which verifies the efficiency of oxidation of the brine which originates from the first dehydrochlorination step of the production for LER was performed using same apparatus as used for photochemical oxidation with sodium hypochlorite under UV lamp. UV lamp was disconnected throughout the whole experiment.

Results of the reduction of TOC content in brines using low-pressure Hg lamp, high-pressure Hg lamp and mere oxidation are presented in Table 2 below. Decrease in efficiency of TOC content reduction in average of 1250 mg/h is apparent when using only mere oxidation with sodium hypochlorite.

TABLE 4
Efficiency of TOC reduction in the first step under specified conditions

| | | | | | | |
|---|---|---|---|---|---|---|
| | | | | TOC | | Specific |
| | Rated | TOC of | TOC of | reduced | Average | energy |
| | power of | brine at | brine at | by the | flow | con- |
| Ex- | emitter | the inlet | the outlet | method | rate | sumption |
| ample | W | mg/l | mg/l | mg/h | l/h | Wh/mg |

UV/NaClO using low-pressure Hg lamp

| | | | | | | |
|---|---|---|---|---|---|---|
| 8.1 | 135 | 2 813 | 364 | 6 123 | 2.5 | 0.0220 |

UV/NaClO using high-pressure Hg lamp

| | | | | | | |
|---|---|---|---|---|---|---|
| 8.2 | 135 | 2 881 | 385 | 6 490 | 2.6 | 0.0193 |

oxidation with NaClO only, no UV lamp

| | | | | | | |
|---|---|---|---|---|---|---|
| 8.3 | — | 2 801 | 810 | 5 057 | 2.54 | — |

### Invention Example 9. Processes Using Systems of UV/NaClO and UV/NaClO with Step b) Treatment Using an Absorber

Further example tests were performed according to Example 6 using brine with higher initial content of TOC at the inlet and higher flow rate of the brine and residence time of the reaction mixture in the reactor.

### Inventive Example 9.1

Example test was carried out using brine originating from the first dehydrochlorination step of the production for LER with concentration of NaCl of more than 290 g/I and TOC content of 3690 mg/I.

Filtration was used for removal of resinous emulsions from brine using filtration crucible with integrated polypropylene filter plate with porosity of 10 μm.

Firstly, brine was acidified using concentrated solution of HCl to achieve a pH value of the brine lower than 2. Brine was then pumped through the glass spiral type heat exchanger into a tube flow reactor having centrally positioned UV-C emitter of low-pressure Hg lamp with 135 W power.

Sodium hypochlorite was dosed into the tube flow reactor at 1.1 to 1.5 times the theoretical consumption of sodium hypochlorite required to oxidize TOC of glycerin according to equation (I).

Step a): photochemical oxidation with UV/NaClO system was carried out at atmospheric pressure, the temperature of 55-62° C. using UV-C radiation at wavelength 254 nm.

An initial content of TOC in brine at the inlet of the reactor was 3690 mg/I, an average flow rate of brine was 2.54 l/h, an average flow rate of sodium hypochlorite was 125 g/h, a residence time of the reaction mixture in the reactor was 0.70 h and the content of TOC was reduced to an average amount of 330 mg/I.

The average amount of reduced content of TOC was 8534 mg/h which corresponds to the specific energy consumption of 0.01582 Wh/mg. The average amount of TOC including dilution factor of the brine with sodium hypochlorite at the inlet was 2813 mg/I. The content of reduced TOC of diluted brine was calculated to an amount of 6307 mg/h which corresponds to the specific energy consumption of 0.0214 Wh/mg. The pH value of the reaction mixture at the outlet was in the range from 4.3 to 7.3 and the concentration of residual sodium hypochlorite at the outlet was less than 200 mg/I.

Residual content of sodium hypochlorite in the formed reaction mixture was further reduced using hydrogen peroxide. Stoichiometric amount was calculated according to equation (III). Hydrogen peroxide was added by a single dose. The reaction mixture was stirred using an overhead stirrer.

Thus treated reaction mixture was then subjected to additional/repeated (Step 2) photochemical oxidation using NaClO under UV lamp under conditions disclosed in Step a1) of Example 6.1.

Step a2): photochemical oxidation using UV/NaClO system was carried out using brine having an initial content of TOC at the inlet of 330 mg/I at an average flow rate of the reaction mixture of 2.04 l/h, an average flow rate of sodium hypochlorite was 11.12 g/h, a residence time of the reaction mixture in the reactor 1.1 h and the content of TOC was reduced to an average amount of 44 mg/I at the outlet.

The average amount of reduced content of TOC in Step a2) photochemical oxidation was 583 mg/h which corresponds to the specific energy consumption of 0.2316 Wh/mg. The average amount of TOC including dilution factor of the brine with sodium hypochlorite was at the inlet 320 mg/I. The content of reduced TOC of diluted brine was calculated to an amount of 563 mg/h which corresponds to the specific energy consumption of 0.2398 Wh/mg.

The pH value of the reaction mixture at the outlet from Step a2) photochemical oxidation was in the range from 5 to 6.5 and the concentration of residual sodium hypochlorite at the outlet was less than 100 mg/I.

Residual content of sodium hypochlorite in the formed reaction mixture was further reduced using hydrogen peroxide. Stoichiometric amount was calculated according to equation (II). Hydrogen peroxide was added by a single dose. The reaction mixture was stirred using an overhead stirrer.

The reaction mixture with an average amount of TOC of 44 mg/I was further re-acidified using concentrated HCl to achieve a pH value lower than 3.5 and then purified in step b)

Step b) treatment is by means of Lewatit® AF5 ion exchange resin. The acidified reaction mixture step a) treatments was fed into the glass flow column filled with ion exchanger.

The flow rate of the reaction mixture was set up to 3.8 BV/h. The average concentration of TOC at the outlet was 7.2 mg/I. The pH value was in the range of 5-9.5.

### Inventive Example 9.2

Example test was carried out using brine originating from the first dehydrochlorination step of the production for LER with concentration of NaCl of more than 290 g/I and TOC content of 3580 mg/I.

Filtration was used for removal of resinous emulsions from brine using filtration crucible with integrated polypropylene filter plate with porosity of 10 μm.

Firstly, brine was acidified using concentrated solution of HCl to achieve a pH value of 0.07. Brine was then pumped through the glass spiral type heat exchanger into a flow column reactor having centrally positioned UV-C emitter of low-pressure Hg lamp with 135 W power.

Sodium hypochlorite with content of 151.6 g/I of active chlorine and 6.98 g/I of chlorates was dosed into the tube flow reactor at 1.0 to 1.5 times the theoretical consumption of sodium hypochlorite required to oxidize TOC of glycerin according to equation (I).

Step a1): photochemical oxidation with UV/NaClO system was carried out at atmospheric pressure, the temperature of 59-61° C. using UV-C radiation at wavelength 254 nm.

An initial content of TOC in brine at the inlet of the reactor was 3580 mg/I, an average flow rate of brine was 2.951/h, an average flow rate of sodium hypochlorite was 130.9 g/h, a residence time of the reaction mixture in the reactor was 0.61 h and the content of TOC was reduced to an average amount of 340 mg/I. Final concentration of chlorates originated in sodium hypochlorite at given flow rate was 1.53 g/I.

The average amount of TOC including dilution factor of the brine with sodium hypochlorite at the inlet was 2798 mg/I. The average amount of reduced content of TOC was 7251 mg/h which corresponds to the specific energy consumption of 0.01880 Wh/mg.

The pH value of the reaction mixture at the outlet was in the range from 4.66 to 5.07, the average concentration of residual sodium hypochlorite at the outlet was 50 mg/I and the average concentration of chlorates at the outlet was 1.53 g/I.

Residual content of sodium hypochlorite in the formed reaction mixture was further reduced using hydrogen peroxide. Stoichiometric amount was calculated according to equation (III). Hydrogen peroxide was added by a single dose. The reaction mixture was stirred using an overhead stirrer.

Thus treated reaction mixture was then subjected to additional/repeated (Step 2) photochemical oxidation using NaClO under UV lamp.

Firstly, brine was acidified using concentrated solution of HCl to achieve a pH lower than 2. Brine was then pumped through the glass spiral type heat exchanger into a tube flow reactor having centrally positioned UV-C emitter.

Sodium hypochlorite with content of 145.6 g/I of active chlorine and 4.52 g/I of chlorates was dosed into the tube flow reactor at 1.0 to 1.5 times the theoretical consumption of sodium hypochlorite required to oxidize TOC of glycerin according to equation (I).

Second Step 2a) photochemical oxidation with UV/NaClO system was carried out at atmospheric pressure, the temperature of 60° C. using UV-C radiation at wavelength 254 nm.

The step a2) photochemical oxidation using UV/NaClO system was carried out using brine having an initial content of TOC at the inlet of 340 mg/I at an average flow rate of the reaction mixture (brine) of 2.06 l/h, an average flow rate of sodium hypochlorite was 11.60 g/h, a residence time of the reaction mixture in the reactor 1.07 h and the content of TOC was reduced to an average amount of 42.10 mg/I at the outlet. The average concentration of chlorates originated in sodium hypochlorite at given flow rate was 0.15 g/I.

The average amount of TOC including dilution factor of the brine with sodium hypochlorite at the inlet was 326 mg/I. The amount of reduced TOC was calculated to an amount of 555 mg/h which corresponds to the specific energy consumption of 0.2431 Wh/mg TOC reduced.

The pH value of the reaction mixture at the outlet from Step 2 photochemical oxidation was in the range from 5.09 to 5.8, the average concentration of residual sodium hypochlorite at the outlet was 56 mg/I and the average concentration of chlorates at the outlet was 1.78 g/I.

Residual content of sodium hypochlorite in the formed reaction mixture was further reduced using hydrogen peroxide. Stoichiometric amount was calculated according to equation (Ill). Hydrogen peroxide with concentration of 50% was added by a single dose at amount of 0.046 ml per one litre of the reaction mixture. The reaction mixture was stirred using an overhead stirrer.

The reaction mixture with an average amount of TOC of 42.10 mg/I was further re-acidified using concentrated HCl to achieve a pH value lower than 3.5 and then purified by means of step b)

Step b) treatment is by means of Lewatit® AF5 ion exchange resin. The acidified reaction mixture step a) treatments was fed into the glass flow column filled with ion exchanger.

### Inventive Example 9.3

Example test was carried out using brine originating from the first dehydrochlorination step of the production for LER with concentration of NaCl of more than 290 g/I and TOC content of 3710 mg/I.

Filtration was used for removal of resinous emulsions from brine using filtration crucible with integrated polypropylene filter plate with porosity of 10 μm.

Firstly, brine was acidified using concentrated solution of HCl to achieve a pH value of 0.14. Brine was then pumped through the glass spiral type heat exchanger into a flow column reactor having centrally positioned UV-C emitter of low-pressure Hg lamp with 135 W power.

Sodium hypochlorite with content of 151.6 g/I of active chlorine and 6.98 g/I of chlorates was dosed into the tube flow reactor at 1.0 to 1.5 times the theoretical consumption of sodium hypochlorite required to oxidize TOC of glycerin according to equation (I).

Step a1): photochemical oxidation with UV/NaClO system was carried out at atmospheric pressure, the temperature of 59-62° C. using UV-C radiation at wavelength 254 nm.

An initial content of TOC in brine at the inlet of the reactor was 3710 mg/I, an average flow rate of brine was 2.94 l/h, an average flow rate of sodium hypochlorite was 134.3 g/h, a residence time of the reaction mixture in the reactor was 0.61 h and the content of TOC was reduced to an average amount of 370 mg/I. Final concentration of chlorates originated in sodium hypochlorite at given flow rate was 1.50 g/I.

The average amount of TOC including dilution factor of the brine with sodium hypochlorite at the inlet was 2882 mg/I. The average amount of reduced content of TOC was 7385 mg/h which corresponds to the specific energy consumption of 0.01828 Wh/mg.

The pH value of the reaction mixture at the outlet was in the range from 5.2 to 5.86, the average concentration of residual sodium hypochlorite at the outlet was 35 mg/I and the average concentration of chlorates at the outlet was 1.50 g/I.

Residual content of sodium hypochlorite in the formed reaction mixture was further reduced using hydrogen peroxide. Stoichiometric amount was calculated according to equation (Ill). Hydrogen peroxide was added by a single dose. The reaction mixture was stirred using an overhead stirrer.

Thus treated reaction mixture was then subjected to additional/repeated (Step 2) photochemical oxidation using NaClO under UV lamp.

Firstly, brine was acidified using concentrated solution of HCl to achieve a pH lower than 2. Brine was then pumped through the glass spiral type heat exchanger into a tube flow reactor having centrally positioned UV-C emitter.

Sodium hypochlorite with content of 145.6 g/I of active chlorine and 4.52 g/I of chlorates was dosed into the tube flow reactor at 1.0 to 1.5 times the theoretical consumption of sodium hypochlorite required to oxidize TOC of glycerin according to equation (I). Step 2 photochemical oxidation with UV/NaClO system was carried out at atmospheric pressure, the temperature of 59-60° C. using UV-C radiation at wavelength 254 nm.

Step a2) photochemical oxidation using UV/NaClO system was carried out using brine having an initial content of TOC at the inlet of 370 mg/I at an average flow rate of the reaction mixture (brine) of 1.97 l/h, an average flow rate of sodium hypochlorite was 15.40 g/h, a residence time of the reaction mixture in the reactor 1.07 h and the content of TOC was reduced to an average amount of 42.10 mg/I at the outlet. The average concentration of chlorates originated in sodium hypochlorite at given flow rate was 0.17 g/I.

The average amount of TOC including dilution factor of the brine with sodium hypochlorite was at the inlet 352 mg/I. The content of reduced TOC of diluted brine was calculated to an amount of 611 mg/h which corresponds to the specific energy consumption of 0.2209 Wh/mg.

The pH value of the reaction mixture at the outlet from step a1) photochemical oxidation was in the range from 4.27 to 5.5, the average concentration of residual sodium hypochlorite at the outlet was less than 80.8 mg/I and the average concentration of chlorates at the outlet was 1.78 g/I.

Residual content of sodium hypochlorite in the formed reaction mixture was further reduced using hydrogen peroxide. Stoichiometric amount was calculated according to equation (III). Hydrogen peroxide with concentration of 50% was added by a single dose at amount of 0.067 ml per one litre of the reaction mixture. The reaction mixture was stirred using an overhead stirrer.

The reaction mixture with an average amount of TOC of 42.10 mg/I was further re-acidified using concentrated HCl to achieve a pH value lower than 3.5 and then purified by means of step b)

Step b) treatment is by means of Lewatit® AF5 ion exchange resin. The acidified reaction mixture step a) treatments was fed into the glass flow column filled with ion exchanger.

The flow rate of the reaction mixture from examples 9.2 and 9.3 was set up to 5.45 BV/h. Breakthrough of TOC above 10 mg/I at the end of column arrived at 18 hours and at total bed volumes of 98.08. The average concentration of TOC at the outlet until breakthrough was 8.01 mg/I. The pH value at the outlet of the column until breakthrough of TOC at 10 mg/I was in the range of 1.83-8.49.

### Inventive Example 9.4

Example test was carried out using brine originating from the first dehydrochlorination step of the production for LER with concentration of NaCl of more than 290 g/I and TOC content of 2360 mg/I.

Filtration was used for removal of resinous emulsions from brine using liquid bag filter with integrated polypropylene filter bag with porosity of 10 μm.

Firstly, brine was acidified using concentrated solution of HCl to achieve a pH value of 0.45. Brine was then pumped into a flow column reactor having centrally positioned medium pressure UV lamp with 3 kW power.

Sodium hypochlorite with content of 135.2 g/I of active chlorine and 12.6 g/I of chlorates was dosed into the tube flow reactor at 1.0 to 1.5 times the theoretical consumption of sodium hypochlorite required to oxidize TOC of glycerin according to equation (I).

Step a1) photochemical oxidation with UV/NaClO system was carried out at the temperature of 60-63° C. using wide-spectrum UV radiation.

An initial content of TOC in brine at the inlet of the reactor was 2360 mg/I, an average flow rate of brine was 41 l/h, an average flow rate of sodium hypochlorite was 11.96 kg/h, a residence time of the reaction mixture in the reactor was 0.2 h and the content of TOC was reduced to an average amount of 305 mg/I. Final concentration of chlorates originated in sodium hypochlorite at given flow rate was 2.27 g/I.

The average amount of TOC including dilution factor of the brine with sodium hypochlorite at the inlet was 1910 mg/I. The average amount of reduced content of TOC was 65820 mg/h which corresponds to the specific energy consumption of 0.0455 Wh/mg.

The pH value of the reaction mixture at the outlet was in the range from 6.0 to 6.8, the average concentration of residual sodium hypochlorite at the outlet was 1 mg/I and the average concentration of chlorates at the outlet was 2.27 g/I.

Residual content of sodium hypochlorite in the formed reaction mixture was further reduced using hydrogen peroxide. Stoichiometric amount was calculated according to equation (III). Hydrogen peroxide was added by a single dose. The reaction mixture was stirred using an overhead stirrer.

Thus treated reaction mixture was then subjected to additional/repeated (Step a2)) photochemical oxidation using NaClO under UV lamp.

Firstly, brine was acidified using concentrated solution of HCl to achieve a pH lower than 2. Brine was then pumped into a flow column reactor having centrally positioned medium pressure UV lamp with 3 kW power.

Sodium hypochlorite with content of 56.9 g/I of active chlorine and 4.32 g/I of chlorates was dosed into the tube flow reactor at 1.0 to 1.5 times the theoretical consumption of sodium hypochlorite required to oxidize TOC of glycerin according to equation (I). Step 2 photochemical oxidation with UV/NaClO system was carried out at the temperature of 59.5-61.5° C. using wide-spectrum UV radiation.

Step a2) photochemical oxidation using UV/NaClO system was carried out using brine having an initial content of TOC at the inlet of 305 mg/I at an average flow rate of the reaction mixture (brine) of 57.3 l/h, an average flow rate of sodium hypochlorite was 4.78 kg/h, a residence time of the reaction mixture in the reactor 0.16 h and the content of TOC was reduced to an average amount of 29.08 mg/I at the outlet. The average concentration of chlorates originated in sodium hypochlorite at given flow rate was 0.28 g/I.

The average amount of TOC including dilution factor of the brine with sodium hypochlorite was at the inlet 286 mg/I. The content of reduced TOC of diluted brine was calculated to an amount of 14722 mg/h which corresponds to the specific energy consumption of 0.2038 Wh/mg.

The pH value of the reaction mixture at the outlet from Step a2) photochemical oxidation was in the range from 6.1 to 6.6, the average concentration of residual sodium hypochlorite at the outlet was 53 mg/I and the average concentration of chlorates at the outlet was 2.6 g/I.

Residual content of sodium hypochlorite in the formed reaction mixture was further reduced using hydrogen peroxide. Stoichiometric amount was calculated according to equation (III). Hydrogen peroxide with concentration of 50% was added by a single dose at amount of 0.04 ml per one litre of the reaction mixture. The reaction mixture was stirred using a drum pump.

The reaction mixture with an average amount of TOC of 29.08 mg/I was further re-acidified using concentrated HCl to achieve a pH value lower than 3.5 and then purified by means of step b)

Step b) treatment is by means of Lewatit® AF5 ion exchange resin. The acidified reaction mixture step a) treatments was fed into the glass flow column filled with ion exchanger.

The flow rate of the reaction mixture was set up to 1.8 BV/h. The average concentration of TOC after bed volume at 7.3 was 3.15 mg/I. The pH value at the outlet was in the range of 3.3-5.5.

### Inventive Example 9.5

Example test was carried out using brine originating from the first dehydrochlorination step of the production for LER with concentration of NaCl of more than 290 g/I and TOC content of 2790 mg/I.

Filtration was used for removal of resinous emulsions from brine using liquid filter bag with integrated polypropylene filter bag with porosity of 10 μm.

Firstly, brine was acidified using concentrated solution of HCl to achieve a pH value of 0.45. Brine was then pumped into a flow column reactor having centrally positioned medium pressure UV lamp with 3 kW power.

Sodium hypochlorite with content of 138.86 g/I of active chlorine and 9.5 g/I of chlorates was dosed into the tube flow reactor at 1.0 to 1.5 times the theoretical consumption of sodium hypochlorite required to oxidize TOC of glycerin according to equation (I).

Step a1) photochemical oxidation with UV/NaClO system was carried out at the temperature of 60.6-63.5° C. using wide-spectrum UV radiation.

An initial content of TOC in brine at the inlet of the reactor was 2760 mg/I, an average flow rate of brine was 41.22 l/h, an average flow rate of sodium hypochlorite was 14.7 kg/h, a residence time of the reaction mixture in the reactor was 0.19 h and the content of TOC was reduced to an average amount of 403 mg/I. Final concentration of chlorates originated in sodium hypochlorite at given flow rate was 2.4 g/I.

The average amount of TOC including dilution factor of the brine with sodium hypochlorite at the inlet was 2171 mg/I. The average amount of reduced content of TOC was 72868 mg/h which corresponds to the specific energy consumption of 0.0412 Wh/mg.

The pH value of the reaction mixture at the outlet was in the range from 6.0 to 6.8, the average concentration of residual sodium hypochlorite at the outlet was 1 mg/I and the average concentration of chlorates at the outlet was 2.4 g/I.

Residual content of sodium hypochlorite in the formed reaction mixture was further reduced using hydrogen peroxide. Stoichiometric amount was calculated according to equation (III). Hydrogen peroxide was added by a single dose. The reaction mixture was stirred using an overhead stirrer.

Thus treated reaction mixture was then subjected to additional/repeated (Step 2) photochemical oxidation using NaClO under UV lamp.

Firstly, brine was acidified using concentrated solution of HCl to achieve a pH lower than 2. Brine was then pumped into a flow column reactor having centrally positioned medium pressure UV lamp with 3 kW power.

Sodium hypochlorite with content of 88.12 g/I of active chlorine and 5.19 g/I of chlorates was dosed into the tube flow reactor at 1.0 to 1.5 times the theoretical consumption of sodium hypochlorite required to oxidize TOC of glycerin according to equation (I). Step 2 photochemical oxidation with UV/NaClO system was carried out at the temperature of 60.2-62.2° C. using wide-spectrum UV radiation.

Step a2) photochemical oxidation using UV/NaClO system was carried out using reaction mixture (brine) having an initial content of TOC at the inlet of 403 mg/I at an average flow rate of the reaction mixture (brine) of 36.37 l/h, an average flow rate of sodium hypochlorite was 4.03 kg/h, a residence time of the reaction mixture in the reactor 0.25 h and the content of TOC was reduced to an average amount of 46.5 mg/I at the outlet. The average concentration of chlorates originated in sodium hypochlorite at given flow rate was 0.66 g/I.

The average amount of TOC including dilution factor of the reaction mixture (brine) with sodium hypochlorite was at the inlet 369 mg/I. The content of reduced TOC of diluted brine was calculated to an amount of 11728 mg/h which corresponds to the specific energy consumption of 0.2558 Wh/mg.

The pH value of the reaction mixture at the outlet from Step a2) photochemical oxidation was in the range from 6.1 to 6.7, the average concentration of residual sodium hypochlorite at the outlet was 15 mg/I and the average concentration of chlorates at the outlet was 3.2 g/I.

Residual content of sodium hypochlorite in the formed reaction mixture was further reduced using hydrogen peroxide. Stoichiometric amount was calculated according to equation (III). Hydrogen peroxide with concentration of 50% was added by a single dose at amount of 0.01 ml per one litre of the reaction mixture. The reaction mixture was stirred using a drum pump.

The reaction mixture with an average amount of TOC of 46.5 mg/I was further re-acidified using concentrated HCl to achieve a pH value lower than 2 and then purified by means of step b)

Step b) treatment is by means of Lewatit® AF5 ion exchange resin. The acidified reaction mixture step a) treatments was fed into the glass flow column filled with ion exchanger.

The flow rate of the reaction mixture was set up to 1.8 BV/h. The average concentration of TOC after bed volume at 7.3 was 3.15 mg/I. The pH value at the outlet was in the range of 3.3-5.5.

The flow rate of the reaction mixture was set up to 1.77 BV/h. Breakthrough of TOC above 10 mg/I arrived at 10 hours and at total bed volumes of 17.7. The average concentration of TOC at the outlet was 5 mg/I. The pH value until breakthrough of TOC at 10 mg/I was in the range of 1.4-6.7.

TABLE 5
Comparison of results - Examples according to present invention

| | | | | | | | | | | | | | | | | | |
|---|---|---|---|---|---|---|---|---|---|---|---|---|---|---|---|---|---|
| | | | | | | | | | | | | | ClO3- | Aver- | | | Aver- |
| | | | | | | | | | | | | ClO3- | con- | age | | | age |
| | | | | | | | | | | | | con- | cen- | ClO3- | | NaClO | ClO3- |
| | | | | | | | | | Aver- | Spe- | | cen- | tra- | con- | | con- | con- |
| | | Tem- | pH | | | final | | | age | cific | | tra- | tion | cen- | Aver- | cen- | cen- |
| | Emit- | pera- | of | | pH | TOC | | | flow | energy | NaClO | tion | in | tra- | age | tra- | tra- |
| | ter | ture | ini- | ini- | of | at | TOC | | rate | con- | initial | in | NaClO | tion | flow | tion | tion |
| | pow- | in the | tial | tial | final | the | re- | Δ | of | sump- | concen- | initial | feed- | at the | rate of | at the | at the |
| Ex- | er | reactor | brine | TOC | brine | outlet | duced | TOC | brine | tion | tration | brine | stock | inlet | NaClO | outlet | outlet |
| ample | W | ° C. | — | mg/l | — | mg/l | mg/h | % | l/h | Wh/mg | g/l | g/l | g/l | g/l | g/h | g/l | g/l |

Step a1): photochemical oxidation with UV/NaClO system

| | | | | | | | | | | | | | | | | | |
|---|---|---|---|---|---|---|---|---|---|---|---|---|---|---|---|---|---|
| 9.2 | 135 | 59-61 | 0.07 | 3 | 4.66- | 340 | 7 251 | 90.50 | 2.95 | 0.0186 | 159.2 | — | 6.98 | 1.53 | 130.9 | 0.050 | 1.53 |
| | | | | 580 | 5.07 | | | | | | | | | | | | |
| 9.3 | 135 | 59-62 | 0.14 | 3 | 5.2- | 370 | 7 385 | 90.03 | 2.94 | 0.0183 | 159.2 | — | 6.98 | 1.56 | 134.3 | 0.035 | 1.50 |
| | | | | 710 | 5.86 | | | | | | | | | | | | |
| 9.4 | 3000 | 60-63 | 0.45 | 2 | 6.0- | 305 | 65 | 87.08 | 41.00 | 0.0455 | 142.0 | — | 12.6 | 2.27 | 11 960 | 0.001 | 2.27 |
| | | | | 360 | 6.9 | | 820 | | | | | | | | | | |
| 9.5 | 3000 | 60.6- | 0.45 | 2 | 6.0- | 403 | 72 | 85.56 | 41.22 | 0.0412 | 145.8 | — | 9.50 | 2.40 | 14 700 | 0.001 | 2.4 |
| | | 63.5 | | 790 | 6.8 | | 868 | | | | | | | | | | |

Step a2): photochemical oxidation with UV/NaClO system

| | | | | | | | | | | | | | | | | | |
|---|---|---|---|---|---|---|---|---|---|---|---|---|---|---|---|---|---|
| 9.2 | 135 | 60 | 1.35 | 340 | 5.09- | 42.1 | 585 | 87.62 | 2.06 | 0.2308 | 152.9 | 1.53 | 4.52 | 0.15 | 11.6 | 0.056 | 1.78 |
| | | | | | 5.8 | | | | | | | | | | | | |
| 9.3 | 135 | 59-60 | 1.32 | 370 | 4.27- | 42.1 | 611 | 88.62 | 1.97 | 0.2209 | 152.9 | 1.50 | 4.52 | 0.17 | 15.4 | 0.081 | 1.76 |
| | | | | | 5.5 | | | | | | | | | | | | |
| 9.4 | 3000 | 59.5- | 1.65 | 305 | 6.1- | 29.08 | 14 | 90.47 | 57.30 | 0.2038 | 59.8 | 2.27 | 4.32 | 0.28 | 4 780 | 0.053 | 2.60 |
| | | 61.5 | | | 6.6 | | 722 | | | | | | | | | | |
| 9.5 | 3000 | 60.2- | 1.10 | 403 | 6.1- | 46.5 | 11 | 88.46 | 36.37 | 0.2558 | 92.53 | 2.40 | 5.19 | 0.66 | 4 030 | 0.015 | 3.20 |
| | | 62.2 | | | 6.7 | | 728 | | | | | | | | | | |

Step b): ion exchange resin purification

| | | | | ClO₃⁻ concentration | |
|---|---|---|---|---|---|
| | Initial TOC of brine | Final TOC of brine | Specific flow rate | at the outlet | pH of the outlet stream |
| | mg/l | mg/l | BV/h | g/l | — |
| 9.2 + | 42.10 | 8.10 | 5.45 | 1.76 | 1.83-8.49 |
| 9.3 | | | | | |
| 9.4 | 29.08 | 3.15 | 1.81 | 2.60 | 3.30-5.5 |
| 9.5 | 46.5 | 5.0 | 1.77 | 3.20 | 1.40-6.7 |

10. Verification of an Efficiency of UV/NaClO System for Effluents Originating from the Epichlorohydrin ECH Production

In order to verify the efficiency of the photochemical oxidation with NaClO and UV lamp, following example tests were carried out using effluents originating from the production process of epichlorohydrin ECH. Such effluents comprising a primary sludge and an aqueous phase are contaminated with organic substances such as glycerin, polyglycerins and calcium acetate and other compounds, and this content of the organic contamination is characterized with Chemical Oxygen Demand, COD_{Cr} indicator. Effluents are characterized with concentration expressed as COD_{Cr} in the range from 1400 to 5000 mg/I and with dissolved inorganic salts content of about 65 g/I. Dissolved inorganic salts comprising mainly calcium chloride.

Following examples were conducted using aqueous phase only without presence of a primary sludge.

### Inventive Example 10.1

Example test was conducted using effluent originating from the production process for epichlorohydrin ECH with an average concentration of chlorides of 44.1 g/I and a TOC content of 1395 mg/I.

Effluent from the production of epichlorohydrin ECH was acidified using concentrated HCl to achieve a pH value less than 2. This acidified waste water was then pumped via the glass spiral type heat exchanger into the flow column reactor with a centrally positioned UV emitter of Hg low pressure lamp with 135 W input power.

Sodium hypochlorite with content of 142.6 g/I of active chlorine and 12.98 g/I of chlorates was dosed into the column tube flow reactor at 0.75 to 1.5 times the theoretical consumption of sodium hypochlorite required to oxidize TOC of glycerin according to equation (I).

Photochemical oxidation with UV/NaClO system was carried out at atmospheric pressure, at the temperature of 60-61° C. using UV radiation done by low-pressure Hg lamp.

Photochemical oxidation with UV/NaClO system was carried out using waste water effluent from the production of epichlorhydrin ECH having an initial content of TOC at the inlet of 1395 mg/I at an average flow rate of the reaction mixture of 1.6 l/h, an average flow rate of sodium hypochlorite was 28.89 g/h, a residence time of the reaction mixture in the reactor 1.3 h and the content of TOC was reduced to an average amount of 76 mg/I at the outlet. The concentration of chlorates coming from sodium hypochlorite feedstock at given reaction mixture flow rate was 1.39 g/I.

The average amount of TOC including dilution factor of the reaction mixture with sodium hypochlorite was at the inlet 1245 mg/I. The content of reduced TOC of diluted brine was calculated to an amount of 1867 mg/h which corresponds to the specific energy consumption of 0.0723 Wh/mg.

The pH value of the reaction mixture at the outlet from photochemical oxidation was in the range from 3.38 to 4.5, the average concentration of residual sodium hypochlorite at the outlet was 64.15 mg/I and the average concentration of chlorates at the outlet was 1.39 g/I.

### Inventive Example 10.2

Example test was conducted using effluent originating from the production process for epichlorohydrin ECH with an average concentration of chlorides of 48.41 g/I and a TOC content of 895 mg/I.

Effluent from the production of epichlorohydrin ECH was acidified using concentrated HCl to achieve a pH value less than 2. This acidified effluent was then pumped via the glass spiral type heat exchanger into the flow column reactor with a centrally positioned UV-C emitter of Hg low pressure lamp with 135 W power.

Sodium hypochlorite with content of 160.4 g/I of active chlorine and 9.27 g/I of chlorates was dosed into the tube flow reactor at 0.75 to 1.5 times the theoretical consumption of sodium hypochlorite required to oxidize TOC of glycerin according to equation (I).

Photochemical oxidation with UV/NaClO system was carried out at atmospheric pressure, at the temperature of 60-61° C. using UV-C radiation at wavelength 254 nm.

Photochemical oxidation with UV/NaClO system was carried out using a waste water effluent from the production of epichlorhydrin ECH, having an initial content of TOC at the inlet of 895 mg/I at an average flow rate of the reaction mixture of 2.34 l/h, an average flow rate of sodium hypochlorite was 26.78 g/h, a residence time of the reaction mixture in the reactor 0.92 h and the content of TOC was reduced to an average amount of 93.3 mg/I at the outlet The concentration of chlorates coming from sodium hypochlorite feedstock at given reaction mixture flow rate was 0.59 g/I.

The average amount of TOC including dilution factor of the reaction mixture with sodium hypochlorite was at the inlet 838 mg/I. The content of reduced TOC of diluted brine was calculated to an amount of 1743 mg/h which corresponds to the specific energy consumption of 0.0775 Wh/mg.

The pH value of the reaction mixture at the outlet from photochemical oxidation was in the range from 4.0 to 4.6, the average concentration of residual sodium hypochlorite at the outlet was 95 mg/I and the average concentration of chlorates at the outlet was 0.59 g/I.

11. Verification of an Efficiency of Advanced Oxidation Process Using UV/H₂O₂ System for Effluents Originating from the Epichlorohydrin Production

In order to verify the efficiency of the advanced oxidation process, AOP with H₂O₂ and UV lamp, following example test was carried out using effluents originating from the production process of epichlorohydrin ECH. Such effluents comprising a primary sludge and an aqueous phase are contaminated with organic substances such as glycerin, polyglycerins and calcium acetate and other compounds, and this content of the organic contamination is characterized with Chemical Oxygen Demand, COD_{Cr} indicator. Effluents are characterized with concentration expressed as COD_{Cr} in the range from 1400 to 5000 mg/I and with dissolved inorganic salts content of about 65 g/I. Dissolved inorganic salts comprising mainly calcium chloride.

Following examples were conducted using aqueous phase only without presence of a primary sludge.

### Inventive Example 11.1

Example test was conducted using effluent originating from the production process for epichlorohydrin ECH with an average concentration of chlorides of 40.9 g/I and a TOC content of 930 mg/I.

Effluent from the production of epichlorohydrin was acidified using concentrated HCl to achieve a pH in the range from 5.0 to 6.0. A solution of H₂O₂ at concentration of 46% in amount of 9.6 ml per one litre of effluent from the production of epichlorohydrin was sequentially added in an amount which corresponds to 0.8 to 0.95 times of the theoretical consumption according to equation (II).

This acidified effluent was then pumped via the glass spiral type heat exchanger into the flow column reactor with a centrally positioned UV-C emitter of Hg low pressure lamp with 135 W power.

Photochemical oxidation with UV/H₂O₂ system was carried out at atmospheric pressure, at the temperature of 59-61.5° C. using UV-C radiation at wavelength 254 nm.

Photochemical oxidation with UV/H₂O₂ system was carried out using waste water effluent from the production of epichlorohydrin ECH having an initial content of TOC at the inlet of 930 mg/I at an average flow rate of the reaction mixture of 1.052 l/h, a residence time of the reaction mixture in the reactor 2.0 h and the content of TOC was reduced to an average amount of 214 mg/I at the outlet. The concentration of chlorates originated in sodium hypochlorite at given flow rate was 0.59 g/I.

The average content of reduced TOC of the reaction mixture was calculated to an amount of 705 mg/h which corresponds to the specific energy consumption of 0.1915 Wh/mg.

The pH value of the reaction mixture at the outlet from the photochemical oxidation with UV/H₂O₂ system was in the range from 6.7 to 7.2, the average concentration of residual hydrogen peroxide at the outlet was 414 mg/I.

### Inventive Example 12.1

Example test was conducted using effluent originating from the production process for polyesters with an average concentration of TOC content of 20280 mg/I.

Effluent from the production of polyesters was acidified using concentrated HCl to achieve a pH value less than 2. This acidified waste water was then pumped via the glass spiral type heat exchanger into the flow column reactor with a centrally positioned UV-C emitter of Hg low pressure lamp with 135 W input power.

Sodium hypochlorite with content of 138.7 g/I of active chlorine was dosed into the column tube flow reactor at 1.0 time the theoretical consumption of sodium hypochlorite required to oxidize TOC of glycerin according to equation (I).

Photochemical oxidation with UV/NaClO system was carried out at atmospheric pressure, at the temperature of 60-63° C. using UV-C radiation at wavelength 254 nm.

Photochemical oxidation with UV/NaClO system was carried out using effluent from the production of polyesters having an initial content of TOC at the inlet of 20280 mg/I at an average flow rate of the reaction mixture (effluent) of 0.503 l/h, an average flow rate of sodium hypochlorite was 123.89 g/h, a residence time of the reaction mixture in the reactor 1.7 h and the content of TOC was reduced to an average amount of 1800 mg/I at the outlet.

The average amount of TOC including dilution factor of the reaction mixture with sodium hypochlorite was at the inlet 7511 mg/I. The average content of reduced TOC was calculated to an amount of 2856 mg/h which corresponds to the specific energy consumption of 0.0473 Wh/mg.

The pH value of the reaction mixture at the outlet from photochemical oxidation was in the range from 6.3 to 6.6, the average concentration of residual sodium hypochlorite at the outlet was 10 mg/I.

| | | Tem- | | | | | | | Aver- | | | ClO3- | ClO3- | Aver- | | | Aver- |
|---|---|---|---|---|---|---|---|---|---|---|---|---|---|---|---|---|---|
| | | pera- | pH | | | | | | age | Spe- | | concen- | concen- | age | Aver- | | age |
| | | ture | of | | pH | final | | | flow | cific | | tration | tration | ClO3- | age | NaClO | ClO3- |
| | Emit- | in | ini- | | of | TOC | | | rate | energy | NaClO | in | in | concen- | flow | concen- | concen- |
| | ter | the | tial | ini- | final | at | TOC | | of | con- | initial | initial | NaClO | tration | rate | tration | tration |
| | pow- | re- | efflu- | tial | efflu- | the | re- | Δ | efflu- | sump- | concen- | efflu- | feed- | at the | of | at the | at the |
| Ex- | er | actor | ent | TOC | ent | outlet | duced | TOC | ent | tion | tration | ent | stock | inlet | NaClO | outlet | outlet |
| ample | W | ° C. | mg/l | mg/l | — | mg/l | mg/h | % | l/h | Wh/mg | g/l | g/l | g/l | g/l | g/h | g/l | g/l |
| 12.1 | 135 | 60- | <2 | 20280 | 6.3- | 1800 | 2856 | 76.04 | 0.503 | 0.0473 | 145.6 | — | — | — | 123.8 | 0.01 | — |
| | | 63 | | | 6.6 | | | | | | | | | | | | |

*General note:
Concentrations of chlorates in the brine waste are below detection limit.

### Inventive Example 13. Process Using System of UV/Chlorine in Step a1) and a2) with Step b) Treatment Using Absorber

This example test was carried out using brine originating from the first dehydrochlorination step of the production for liquid epoxy resin (LER). The brine had a concentration of NaCl of greater than 290 g/I and a TOC content of 5400 mg/I.

Filtration was used for the removal of resinous emulsions from brine, using a liquid bag filter which had an integrated polypropylene filter bag with a porosity of 10 μm. The brine was pumped into a flow column reactor which was adapted with a centrally positioned medium pressure UV lamp with 6 kW power. 100% chlorine and sodium hydroxide aqueous solution with concentration of 20% (with content of 1.73 mg/I of chlorates) was dosed into the flow column reactor. Sodium hydroxide was diluted as concentrated hydroxide results in very low flow heavily controlled in this experiment. More concentrated hydroxide can be also used in the embodiment provided good flow control is secured. Chlorine was dosed at 0.9 to 1.0 times the theoretical consumption of chlorine required to oxidize the TOC having glycerin as component. Sodium hydroxide solution was dosed to achieve a pH value kept in the range of 5.3-6.2.

Step a1) photochemical oxidation with UV/chlorine system was carried out at the temperature of 59-63° C. using wide-spectrum UV radiation.

An initial content of TOC in brine at the inlet of the reactor was 5400 mg/I, an average flow rate of brine was 45.65 l/h, an average flow rate of sodium hydroxide aqueous solution with concentration of 20% was 17.045 kg/h, an average flow rate of 100% chlorine was 2990 g/h, a residence time of the reaction mixture in the reactor was 0.2 h and the content of TOC was reduced to an average amount of 611 mg/I.

The average amount of TOC including dilution factor of the brine with sodium hydroxide at the inlet was 4092 mg/I. The average amount of reduced content of the TOC at the outlet was 209.7 g/h which corresponds to the specific energy consumption of 0.02861 Wh/mg.

The pH value of the reaction mixture at the outlet was in the range from 5.3 to 6.2, the average concentration of active chlorine at the outlet was less than 1 mg/I and the average concentration of chlorates at the outlet was 0.35 g/I.

The above treated reaction mixture was then subjected to additional/repeated (Step a2) photochemical oxidation using chlorine under UV lamp, as described below.

The reaction mixture was pumped into a flow column reactor having centrally positioned medium pressure UV lamp with 6 kW power. 100% chlorine and sodium hydroxide aqueous solution with concentration of 5% (with content of 0.43 mg/I of chlorates) was dosed into the flow column reactor. Sodium hydroxide was diluted as concentrated hydroxide results in very low flow heavily controlled in this experiment. 20% or even more concentrated hydroxide can be used in the embodiment provided good flow control is secured. Chlorine was dosed at 0.95 to 1.0 times the theoretical consumption of chlorine required to oxidize TOC of glycerin. Sodium hydroxide solution was dosed to achieve a pH value in the range of 5.8-6.1.

Step a2) photochemical oxidation with UV/chlorine system was carried out at the temperature of 59-62° C. using wide-spectrum UV radiation.

An initial content of TOC in brine at the inlet of the flow column reactor was 611 mg/I, an average flow rate of brine was 50.79 l/h, an average flow rate of sodium hydroxide aqueous solution with concentration of 5% was 9.29 kg/h, an average flow rate of 100% chlorine was 403 g/h, a residence time of the reaction mixture in the reactor was 0.16 h and the content of TOC was reduced to an average amount of 77 mg/I. The average amount of TOC including dilution factor of the brine with sodium hydroxide at the inlet was 519 mg/I. The average amount of reduced content of TOC of the reaction mixture was 26398 mg/h which corresponds to the specific energy consumption of 0.2273 Wh/mg.

The pH value of the reaction mixture at the outlet of Step a2) photochemical oxidation was in the range from 5.8 to 6.1, the average concentration of residual active chlorine at the outlet was 10 mg/I and the average concentration of chlorates at the outlet was 0.83 g/I.

The residual content of active chlorine in the reaction mixture, after the treatment in the flow reactor above, was further reduced using hydrogen peroxide. The resultant reaction mixture was placed in a vessel with a drum pump. Stoichiometric amount of the hydrogen peroxide was calculated according to equation (III).

The hydrogen peroxide with concentration of 50% was as a single dose at amount of 0.008 ml per one litre of the reaction mixture. The reaction mixture was stirred using the drum pump.

The reaction mixture with an average amount of TOC of 77 mg/I was finally treated by acidification using concentrated HCl to achieve a pH value lower than 1.0 and subjected to post-treatment with absorber Lewatit® AF5 microporous ion exchange resin. The acidified reaction mixture was fed into glass flow columns filled with ion exchanger, and which columns were connected in series. The Ion exchanger used was regenerated by using sodium hydroxide aqueous solution with concentration of 3% at the temperature of 87-90° C.

The flow rate of the reaction mixture was set up to 1.63 BV/h. The average concentration of TOC at the outlet was 7.5 mg/I.

The table below shows the reduction of the TOC, while ensuring the chlorate concentration was kept low.

TABLE 6
Results - Example according to present invention

| | | | | | | | | | | | Aver- | | | ClO3- | | Aver- | Aver- |
|---|---|---|---|---|---|---|---|---|---|---|---|---|---|---|---|---|---|
| | | | | | | | | | Aver- | Spe- | age | Aver- | | concen- | ClO3- | age | age |
| | | Tem- | pH | | | final | | | age | cific | flow | age | | tration | concen- | chlorine | ClO3- |
| | Emit- | pera- | of | | pH | TOC | | | flow | energy | rate | flow | NaOH | in | tration | concen- | concen- |
| | ter | ture | ini- | ini- | of | at | TOC | | rate | con- | of | rate | initial | NaOH | in | tration | tration |
| Ex- | pow- | in the | tial | tial | final | the | re- | Δ | of | sump- | chlo- | of | concen- | feed- | Initial | at the | at the |
| ample | er | reacto | brine | TOC | brine | out- | duced | TOC | brine | tion | rine | NaOH | tration | stock | brine | outlet | outlet |
| 13 | W | ° C. | mg/l | mg/l | — | let | mg/h | % | l/h | Wh/mg | g/h | kg/h | % | mg/l | g/h | g/l | g/l |

Step a1): photochemical oxidation with UV/chlorine system

| | | | | | | | | | | | | | | | | |
|---|---|---|---|---|---|---|---|---|---|---|---|---|---|---|---|---|
| 6000 | 59-63 | 7.1 | 5400 | 5.3- | 611 | 209 713 | 85.06 | 45.65 | 0.02861 | 2990 | 17.045 | 20 | 1.73 | — | <0.001 | 0.35 |
| | | | | 6.2 | | | | | | | | | | | | |

Step a2): photochemical oxidation with UV/chlorine system

| | | | | | | | | | | | | | | | | |
|---|---|---|---|---|---|---|---|---|---|---|---|---|---|---|---|---|
| 6000 | 59-62 | 5.8 | 611 | 5.8- | 77 | 26 398 | 85.16 | 50.79 | 0.2273 | 403 | 9.29 | 5 | 0.43 | 0.35 | 0.01 | 0.83 |
| | | | | 6.1 | | | | | | | | | | | | |

Step b): ion exchange resin purification

| Initial TOC of brine | final TOC of brine | Specific flow rate | ClO₃⁻ concentration at the outlet |
|---|---|---|---|
| mg/l | mg/l | BV/h | g/l |
| 77 | 7.5 | 1.63 | 0.83 |

1. A process for removal of TOC from industrial aqueous waste streams which have TOC of 350000 mg/I or less and various pH, wherein the process comprises a plurality of successive steps comprising in each step electromagnetic irradiation in the region 200 nm-600 nm at a temperature of less than 70° C. for photo oxidation of the waste streams using chlorine as an oxidant.

2. The process of claim 1, wherein the oxidant is used in a stoichiometric excess to TOC of from 0.5:1.0 to 5.0:1.0.

3. The process of claim 1, wherein an additional oxidant is selected from hypochlorites and peroxides.

4. The process of claim 1, wherein the photo oxidation of the waste streams using an added oxidant is carried out under pH lower than 7.0.

5. The process of claim 1 where the photo oxidation is conducted under low pressure conditions, such as atmospheric or low range superatmospheric pressure, i.e. at a pressure in the range from about 100 kPa to about 150 kPa.

6. The process of claim 1, wherein, following the plurality of photo oxidation steps, the waste streams are treated with at least one physical adsorber to achieve final TOC 10000 mg/I or less, 1000 mg/I or less, 100 mg/I or less, 50 mg/I or less, 25 mg/I or less, 15 mg/I or less, 10 mg/I or less, 5 mg/I or less.

7. The process of claim 6, wherein the physical adsorber is selected from the group consisting of microporous absorbers, such as microporous activated carbon with uniform cells size, microporous zeolites, or carbonaceous compounds, such as graphene, or carbon nanotubes.

8. The process of claim 6, wherein, prior to treatment with physical absorbers, the pH of the treated streams is reduced to below 6.

9. The process of claim 6, wherein the resulting stream is recycled to the process of claim 1.

10. The process of any one of the preceding claims, wherein industrial waste water streams are used that come from i) the production of Liquid Epoxy Resin (LER) using the alkaline reaction of various bisphenols, hydrogenated bisphenols, and epichlorohydrin or dichloropropanol, ii) the production of epichlorohydrin (ECH) from dichloropropanol using alkaline reagents, iii) the production of unsaturated polyesters from acids, anhydrides and alcohols, iv) the brine from a chloro-alkali plant and/or v) the waste water generally from dehydrochlorination processes, more specifically dehydrochlorination of chlorohydrins or chlorinated C3-C6 hydrocarbons.

11. The process of any one of the preceding claims, wherein the TOC organic materials in the industrial water waste include linear and cyclic polyols, esterified polyols, oxygenated poll compounds, chlorinated polyol compounds and/or other compounds, e.g. glycerin, polyglycerines, glycidol, monochloroproanediol, dichloroproanol, ethyleneglycol, propyleneglycol, 2,3-dichloropropanoyl acid.

12. The process of any one of the preceding claims, wherein the TOC organic residues comprises combinations of higher order, e.g. C3-C5 oxygenated compounds, such as polyols, chlorinated and/or hydroxylated, carboxylic acids or esters, oligomers, and maybe present in amounts 500 mg/I, 250 mg/I, 100 mg/I, 50 mg/I, or 25 mg/I or 20 mg/I, or 15 mg/I.
